(19) United States
(12) Patent Application Publication
(10) Pub. No.: US 2026/0264052 A1
(43) Pub. Date: Sep. 10, 2026

(54) ONE-POT ELECTROSPUN SPINEL FERRITE/PEROVSKITE OXIDE NANOFIBER CATALYSTS FOR ENERGY HARVESTING AND CONVERSION

(71) Applicant: Khalifa University of Science And Technology, Abu Dhabi (AE)

(72) Inventors: Anifat Adenike Bankole, Abu Dhabi (AE); Maguy Abi Jaoude, Abu Dhabi (AE)

(21) Appl. No.: 19/074,101

(22) Filed: Mar. 7, 2025

(51) Int. Cl. B01J 23/00; B01J 23/889; B01J 35/45; B01J 37/00; B01J 37/08

(52) U.S. Cl. CPC B01J 23/005; B01J 23/8892; B01J 35/45; B01J 37/0045; B01J 37/08

(57) ABSTRACT

Disclosed are catalyst compositions, methods of producing a heterostructure, and methods of catalyzing a reaction using the catalyst composition. The composition may include a photothermal perovskite oxide and at least one transition metal spinel ferrite. The photothermal perovskite may have a general formula of ABO₃. The at least one transition metal spinel ferrite may have a general formula of AₓB₃₋xO₄.

### BACKGROUND OF THE INVENTION

Catalyst design and geometry play a pivotal role in determining the selectivity and performance of a particular catalytic process. For many established and emerging reactions in the fields of (i) chemical synthesis, (ii) green/low-carbon fuel production, and (iii) environmental depollution, traditional heterogeneous catalysis strikes are carbon-energy intensive and suffer from limited selectivity of existing industrial catalysts.

In photothermal catalysis, the absorption and conversion of abundant, cost-effective, and renewable solar/infra-red energy into heat is highly desirable to de-fossilize/reduce the energy requirement of the catalytic process while creating additional paths for cooperative photocatalysis to take place. The components of a photothermal catalyst determine its efficiency at (i) converting light to heat and (ii) activating the thermal pathway, photocatalytic pathway, or both. Therefore, integrating suitable materials that function as photothermal converters, thermal catalysts, and photocatalysts into one technology to harness superior properties to those achievable by the individual constituents is a technological challenge.

Similarly, to date, only single oxide fibers have been documented for such catalytic reactions due to the ease of configuration. However, single oxide fibers are less efficient, and are used in single catalytic reactions. Additionally, the methods for generating such structures are typically multi-step, cumbersome, time-consuming, and create extra waste.

Further research and development are needed in order to unlock the full potential of using a single system design and catalyst precursors to produce catalysts that are multifunctional.

### BRIEF SUMMARY OF THE INVENTION

Covered embodiments of the present disclosure are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

Embodiments of the present disclosure include a catalyst composition that includes a photothermal perovskite oxide and at least one transition metal spinel ferrite. The ratio of the photothermal perovskite oxide to at least one transition metal spinel ferrite may be from 1:10 to 10:1. The multi-metallic catalyst described herein may be used in various catalytic reactions including photothermal catalysis. The at least one transition metal spinel ferrite may have a formula of AₓB₃₋ₓO₄, where A is selected from Co, Ni, Zn, Mn, and Fe, O is oxygen, and B is Fe. Similarly, the perovskite oxide may have a chemical formula of ABO₃ where A is an alkali earth metal cation or rare earth metal cation, B may be a transition metal cation, and O is oxygen.

Another embodiment is directed to a method for producing the multi-metallic heterostructure. The method may include preparing a first solution (a) that may be the spinel ferrite precursor and similarly preparing solution (b) that may be the perovskite oxide precursor. The method may include concentrically configured needles placed a distance from a rotating drum where the solution, when sprayed out of the concentric needle tips, travels a distance through air to reach the drum surface. Similarly, the method may include applying a voltage to the needles and grounding the drum to produce a charged solution as the mixing solution exits the needle tips. The drum may be rotating at a rate of up to 2000 RPM to produce a nanofiber catalyst composition on the surface of the drum.

Further aspects, objects, and advantages will become apparent upon consideration of the detailed description.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 illustrates a flow chart of a method for producing a spinel ferrite/perovskite oxide metal catalyst according to aspects of the disclosure.

FIG. 2 illustrates example powder X-ray diffraction (p-XRD) patterns for MFe₂O₄/LaMnO₃ composite fibers and their respective single oxide fibers when M=Co (a), M=Ni (b), and M=Cu (c) according to aspects of the disclosure.

FIG. 3 illustrates example p-XRD patterns for five different samples of CoFe₂O₄/LaMnO₃ composite fibers (C1-C5) and respective controls according to aspects of the disclosure.

FIG. 4 illustrates example p-XRD patterns of five different samples of NiFe₂O₄/LaMnO₃ composite fibers (C′1-C′5) and their controls according to aspects of the disclosure.

FIG. 5 illustrates an example p-XRD pattern of CuFe₂O₄/LaMnO₃ fibers post-calcination at 600° C. and 700° C. according to aspects of the disclosure.

FIG. 6 illustrates transmission electron microscopy (TEM) images (a-e), selected area electron diffraction patterns (f-j), and high resolution transmission electron microscopy (HR-TEM) and corresponding Fast Fourier Transformation pattern analysis (k-o) for MFe₂O₄/LaMnO₃ (where M=Co, Ni) according to aspects of the disclosure. Scale bar: (a-e, 200 nm), (f-j, 5 l/nm reciprocal space), (k-o, 20 nm).

FIG. 7 illustrates bright-field TEM images of a CoFe₂O₄/LaMnO₃ fiber and an enlarged view of the interface (black arrow) formed between crystallites of the two constituent semiconductor oxides.

FIG. 8 illustrates bright-field TEM images (a,b) of CoFe₂O₄/LaMnO₃ fibers from replicate batch 1 were measured at an acceleration voltage of 200 keV. (c) The fast Fourier Transform analysis result of the entire TEM image window is shown in (b) according to aspects of the disclosure.

FIG. 9 illustrates bright-field TEM (a) and HR-TEM (b) images of NiFeO₄/LaMnO₃ nanocomposite fibers sampled from the extra replicate batch. Image (c) is an FFT pattern of (b) with diffraction spots indexed to LaMnO₃ (110) and NiFe₂O₄ (200) crystallographic planes according to aspects of the disclosure.

FIG. 10 illustrates example p-XRD patterns of Co_{0.5}Ni_{0.5}Fe₂O₄/LaMnO₃ fibers and those of the individual oxides prepared under the same synthesis/post-calcination conditions according to aspects of the disclosure.

FIG. 11 illustrates example scanning electron microscopy (SEM) photographs of the prepared nanocomposite spinel ferrite-LaMnO₃ nanofibers (a) CoFe₂O₄/LaMnO₃ and (b) NiFe₂O₄/LaMnO₃ and their corresponding overlayed elemental EDX maps according to aspects of the disclosure. Scale bar=1 μm.

FIG. 12 illustrates SEM images of electrospun nanocomposite fibers (a) CoFe₂O₄/LaMnO₃ and (b) NiFe₂O₄/LaMnO₃ at low magnification (left, scale bar=1 μm) and high magnification (right, scale bar=100 nm) according to aspects of the disclosure.

FIG. 13 illustrates energy dispersive x-ray spectra of (a) CoFe₂O₄/LaMnO₃ and (b) NiFe₂O₄/LaMnO₃ composite nanofibers according to aspects of the disclosure.

FIG. 14 illustrates SEM-EDX images and elemental mapping of two matches of CuFe₂O₄/LaMnO₃ fibers according to aspects of the disclosure. Scale bar of EDX maps=20 μm.

FIG. 15 illustrates SEM-EDX images and elemental mapping of Co_{0.5}Ni_{0.5}Fe₂O₄/LaMnO₃ composite fibers according to aspects of the disclosure. Scale bar of EDX maps=20 μm.

FIG. 16 illustrates SEM-EDX images of five different batches of CoFe₂O₄/LaMnO₃ composite fibers according to aspects of the disclosure. Scale bar for EDX maps=15 μm.

FIG. 17 illustrates a graph of semi-quantitative EDX analysis of the average metal (M) composition in composition in CoFe₂O₄/LaMnO₃ fibers using five batches (N=5) according to aspects of the disclosure.

FIG. 18 illustrates a graph of the comparison of means of atomic ratios (M:La) across five batches of CoFe₂O₄/LaMnO₃ composite fibers according to aspects of the disclosure.

FIG. 19 illustrates SEM-EDX images of five different batches of NiFe₂O₄/LaMnO₃ composite fibers according to aspects of the disclosure. Scale bar for EDX maps=10 μm (batches 1-4) and 20 μm (batch 5).

FIG. 20 illustrates a graph of semi-quantitative EDX showing the average metal (M) composition in five batches (N=5) of NiFe₂O₄/LaMnO₃ fibers according to aspects of the disclosure.

FIG. 21 illustrates a graph of the means of atomic ratios (M:La) across five batches of NiFe₂O₄/LaMnO₃ composite fibers according to aspects of the disclosure.

FIG. 22 illustrates a graph of the liquid N₂ adsorption/desorption isotherms (at 77K) (a) and a graph of the pore size distribution of CoFe₂O₄, NiFe₂O₄, LaMnO₃, CoFe₂O₄/LaMnO₃, and NiFe₂O₄/LaMnO₃ fibers (b) according to aspects of the disclosure.

FIG. 23 illustrates a graph of the Liquid N₂ adsorption/desorption isotherms (at 77 K) (a) and a graph of the pore size distribution (b) with cumulative pore volume analysis for CoFe₂O₄/LaMnO₃ fibers sampled from its associated batch 1 according to aspects of the disclosure.

FIG. 24 illustrates a graph of the Liquid N₂ adsorption/desorption isotherms (at 77 K) (a) and a graph of the pore size distribution (b) with cumulative pore volume analysis for a sample of NiFe₂O₄/LaMnO₃ fibers obtained from the reproduced Batch 1 of this composite material according to aspects of the disclosure.

FIG. 25 illustrates graphs of deconvoluted high-resolution vacuum core x-ray photoelectron spectroscopy (XPS) spectra of CoFe₂O₄/LaMnO₃ nanofibers. (a) Co-2p, (b) Fe-2p, (c) O-1s, (d) La-3d, and (e) Mn-2p according to aspects of the disclosure. *Satellite peak.

FIG. 26 illustrates graphs of deconvoluted/mapped high-resolution vacuum XPS spectra of NiFe₂O₄/LaMnO₃ nanofibers. (a) Ni-2p, (b) Fe-2p, (c) O-1s, (d) La-3d, and (e) Mn-2 according to aspects of the disclosure. *Satellite peaks.

FIG. 27 illustrates graphs of tauc plot analysis of the indirect bandgap for the control spinel ferrites and perovskite fibers (a) CoFe₂O₄, (b) NiFe₂O₄, (c) LaMnO₃, (d) NiFe₂O₄/LaMnO₃, (e) CoFe₂O₄/LaMnO₃ and their heterocomposites based on UV-vis-NIR DRS measurements, using the Kulbelka-Munk function according to aspects of the disclosure.

FIG. 28 illustrates ultraviolet-visible diffuse reflectance spectroscopy (UV-vis DRS) graphs by the Kubelka-Munk plot of the indirect bandgap for CoFe₂O₄/LaMnO₃ composite fibers according to aspects of the disclosure.

FIG. 29 illustrates (UV-vis DRS) graphs by the Kubelka-Munk plot of the indirect bandgap for NiFe₂O₄/LaMnO₃ composite fibers according to aspects of the disclosure.

FIG. 30 illustrates XPS vacuum survey spectra of the highest core energy regions of (a) CoFe₂O₄, LaMnO₃ and their heterocomposite, and (b) NiFe₂O₄, LaMnO₃, and their heterocomposite according to aspects of the disclosure.

FIG. 31 illustrates XPS vacuum survey spectra of the valence band maximum (VBM) energy regions of the spinel ferrite and lanthanum manganite control fibers (a-e) and their heterocomposites (d,e) according to aspects of the disclosure.

FIG. 32 illustrates the energy band diagrams for CoFe₂O₄/LaMnO₃ heterocomposite fibers according to aspects of the disclosure.

FIG. 33 illustrates energy band diagrams for NiFe₂O₄/LaMnO₃ heterocomposite fibers according to aspects of the disclosure.

FIG. 34 illustrates thermal images (a and b) of the surface temperature of CoFe₂O₄/LaMnO₃ nanofiber catalysts during IR radiation according to aspects of the disclosure.

FIG. 35 illustrates a photograph and schematic illustration of the custom photothermal catalytic reactor setup used for toluene oxidative degradation experiments according to aspects of the disclosure.

FIG. 36 illustrates graphs of the toluene conversion during 2-hour continuous flow photothermal catalytic (PTC) oxidation for batches of CoFe₂O₄/LaMnO₃ nanofiber PTC-1 (a) and PTC-2 (b) according to aspects of the disclosure.

FIG. 37 illustrates graphs of the toluene conversion during 2-hour continuous flow thermal catalytic oxidation over three pristine samples from separate batches of CoFe₂O₄/LaMnO₃ nanofiber composite TC-1 (a), TC-2 (b), TC-3 (c), and controls (d,e) and TEM images of control fibers according to aspects of the disclosure.

FIG. 38 illustrates a graph of the one-way ANOVA analysis of the photothermal and thermal catalytic oxidation pair of results shown in FIG. 36 (a,b) and FIG. 37(b,c).

FIG. 39 illustrates a graph of the Tukey test for toluene conversion attained with different batches of CoFe₂O₄/LaMnO₃ fibers under photothermal catalysis (PTC-1/PTC-2) and thermal catalysis (TC-2/TC-3) according to aspects of the disclosure.

FIG. 40 illustrates in-situ diffuse reflectance infrared Fourier transform (DRIFT) spectra recorded at different intervals during simulated thermal and photothermal catalysis experiments over CoFe₂O₄ and LaMnO₃ control fibers and their heterostructured composite CoFe₂O₄/LaMnO₃ according to aspects of the disclosure.

FIG. 41 illustrates graphs of the cyclic stability of CoFe₂O₄/LaMnO₃ nanofibers of FIG. 36(a).

FIG. 42 illustrates bright-field TEM image (a), a HR-TEM image (b), and an FFT of (b) to produce (c) for spent CoFe₂O₄/LaMnO₃ fiber catalysts according to aspects of the disclosure.

FIG. 43 illustrates a graph of the time-on-stream stability of CoFe₂O₄/LaMnO₃ fiber catalyst during 50-hour continuous flow photothermal catalytic oxidation of toluene according to aspects of the present disclosure.

FIG. 44 illustrates an attenuated total reflectance-Fourier transform infrared (ATR-FTIR) spectrum of a sample of spent CoFe₂O₄/LaMnO₃ fiber catalyst following the time on stream test reported in FIG. 43.

FIG. 45 illustrates graphs of deconvoluted high-resolution vacuum XPS spectra of the core levels in spent CoFe₂O₄/LaMnO₃ nanofibers following their use in 50-hour continuous flow photothermal catalytic oxidation of toluene as reported in FIG. 22 (a) Co-2p, (b) Fe-2p, (c) O-1s, (d) La-3d, and (e) Mn-2p according to aspects of the disclosure. *Satellite peak.

FIG. 46 illustrates a bright-field TEM image (a), a HR-TEM image (b), and an FFT (c) of the HR-TEM image for spent CoFe₂O₄/LaMnO₃ fiber catalysts collected after 50-hour continuous flow photothermal catalytic oxidation of toluene according to aspects of the disclosure.

FIG. 47 illustrates a graph of the p-XRD pattern of the spent CoFe₂O₄/LaMnO₃ fiber catalyst after the 50-hour time-one stream test according to aspects of the present disclosure.

### DETAILED DESCRIPTION OF THE INVENTION

Before the present disclosure is described in detail, it is to be understood that the terminology used herein is for purposes of describing particular examples and embodiments only, and is not intended to be limiting.

In this specification and in the claims that follow, reference will be made to a number of terms that shall be defined to have the following meanings:

### Definitions

Articles “a” and “an” are used herein to refer to one or to more than one (i.e., at least one) of the grammatical object of the article. By way of example, “an element” means at least one element and can include more than one element.

As used herein, the terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

The terms “about” and “approximately” as used herein shall generally mean an acceptable degree of error for the quantity measured given the nature or precision of the measurements. Exemplary degrees of error are within 20% (%); preferably, within 10%; and more preferably, within 5% of a given value or range of values. Any reference to “about X” or “approximately X” specifically indicates at least the values X, 0.95X, 0.96X, 0.97X, 0.98X, 0.99X, 1.01X, 1.02X, 1.03X, 1.04X, and 1.05X. Thus, expressions “about X” or “approximately X” are intended to teach and provide written support for a claim limitation of, for example, “0.98X.” Numerical quantities given herein are approximate unless stated otherwise, meaning that the term “about” or “approximately” can be inferred when not expressly stated. When “about” is applied to the beginning of a numerical range, it applies to both ends of the range.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

Unlike nanorods, one-dimensional (1D) nanofibers are known to have a high aspect ratio (length-to-diameter ratio), which allows them to be easily handled and upscaled for achieving similar or superior physicochemical properties in various applications that are sensitive to quantum chemical effects (e.g., optoelectronics, photothermal materials, gas sensing, catalysis, electrochemical fuel cells, and battery electrodes). Quantum chemical confinement in 1D fibers is preserved when the latter are used as building blocks to prepare scaffolded materials. To produce 1D fibers, the electrospinning technique is the state-of-the-art approach for fiber deposition while offering flexibility for morphology, texture, and compositional tuning of a range of organic, inorganic, and hybrid materials and the preparation of customized non-woven 3D fabrics from their 1D nanofibers.

Thus, the present disclosure is directed to the development of 1D hetero-structured composite nanofibers comprising a photothermal perovskite oxide and a transition-metal spinel ferrite by using a one-pot synthesis approach from the starting precursors of the two systems.

### Catalyst Composition

In some embodiments, the catalyst composition described herein may include a photothermal perovskite oxide and at least one transition metal spinel ferrite. The ratio of the photothermal perovskite oxide to the at least one transition metal spinel ferrite is from 1:10 to 10:1. For example, the ratio of perovskite oxide to the at least one transition metal spinel ferrite is from 1:10 to 9:1, 1:10 to 8:1, 1:10 to 7:1, 1:10 to 6:1, 1:10 to 5:1, 1:10 to 4:1, 1:10 to 3:1, 1:10 to 2:1, 1:10 to 1:1, 2:10 to 10:1, 3:10 to 10:1, 4:10 to 10:1, 5:10 to 10:1, 6:10 to 10:1, 7:10 to 10:1, 8:10 to 10:1, or 9:10 to 10:1, or any value or range including 1:1, 1:2, 1:3, 1:4, 1:5, 1:6, 1:7, 1:8, 1:9, 1:10, 10:1, 9:1, 8:1, 7:1, 6:1, 5:1, 4:1, 3:1, or 2:1.

In some embodiments, the at least one transition metal spinel ferrite has a chemical formula of AₓB₃₋xO₄. In some embodiments, A is selected from Co, Ni, Zn, Mn, and Fe, B is Fe, and O is oxygen. For example, the transition metal spinel may be produced from any one of the transition metals known by those skilled in the art. In some embodiments, the at least one transition metal spinel ferrite is NiFe₂O₄, CoFe₂O₄, CuFe₂O₄, and Co_{0.5}Ni_{0.5}Fe₂O₄. In some embodiments, the nanofiber composite is produced from a hybrid multi-metallic system. For example, the hybrid system may include more than one transition metal spinel ferrite in combination with the primary perovskite. For example, described herein are novel nanofiber composites that include NiFe₂O₄ and CoFe₂O₄ as the spinel ferrite oxide. In some embodiments, the solution may be produced from more than one metal precursor salt, including but not limited to iron nitrate(III) nonahydrate (Fe(NO₃)₃·9H₂O), anhydrous cobalt(II) acetate (Co(CH₃CO₂)₂), nickel(II) acetate tetrahydrate (Ni(CH₃CO₂)₂·4H₂O), and anhydrous copper(II) acetate (Cu(CH₃CO₂)₂). In some embodiments, the spinel ferrite oxide precursor solution may be produced from the iron nitrate(III) nonahydrate (Fe(NO₃)₃·9H₂O) and one other metal salt precursor. For example, solution (a) may be produced from iron nitrate(III) nonahydrate (Fe(NO₃)₃·9H₂O) and anhydrous copper(II) acetate (Cu(CH₃CO₂)₂) to produce a solution of CuFe₂O₄ precursor. In other such configurations, solution (a) precursor may be CuFe₂O₄, CoFe₂O₄, NiFe₂O₄. In some embodiments, the transition metal spinel ferrite may be a mixture of transition metals. In one non-limiting example, the mixture of transition metals in the spinel ferrite may be Co_{0.5}Ni_{0.5}Fe₂O₄.

Perovskite materials have demonstrated remarkable light-absorbing capabilities. Particularly, lanthanum manganite (LaMnO₃) is known for its infrared (IR) vibrational excitation for its very short bandgap energy (as low as 0.5-0.9 eV, corresponding to 2500-1400 nm, respectively), which makes it suitable for near IR/broad-spectrum solar photothermal energy harvesting. Incorporating LaMnO₃ may enhance the nanofiber's ability to convert light into heat. Similarly, the incorporation of LaMnO₃ may be a significant advantage, particularly in photothermal catalytic air pollution treatment and solar fuel production applications, where light-to-heat conversion may eliminate/reduce the thermal energy input supplied from fossil-fuel-powered heating sources. In some embodiments, the perovskite oxide used in the catalyst may have a formula ABO₃. In some embodiments, A may be an alkaline earth metal or rare earth metal cation, B may be a transition-metal cation, and O may be oxygen. For example, the rare earth metal cation may be lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), scandium (Sc) or yttrium (Y). In some embodiments, the alkaline earth metal cation may be beryllium (Be), magnesium (Mg), calcium (Ca), strontium (Sr), barium (Ba), or radium (Ra). In some embodiments, the transition metal cation may be any 1+ oxidation state, 2+ oxidation state, 3+ oxidation state or 4+ oxidation state transition metal cation. For example, the transition metal cation may be iron(II), or iron(III).

In some embodiments, the perovskite oxide is any one of lanthanum manganite, strontium titanate, calcium titanate, lead titanate, bismuth ferrite, lanthanum cobaltite, lanthanum nickelate, lanthanum ferrite and lanthanum ytterbium oxide.

Combining LaMnO₃ with a spinel ferrite (MFe₂O₄) may have additional benefits. Considering their semiconductor properties and solar light photoactivity, both lanthanum manganite (LaMnO₃) and metal ferrites (MFe₂O₄) can manifest interfacial interactions that may serve to boost/regulate the surface temperature of the catalysts and/or mediate the secondary photocatalytic pathway when the energy bands of the two systems are aligned to form cooperative electronic heterojunctions. Both LaMnO₃ and spinel ferrites may have very close valence and conduction energy bands, which may be conducive for straddling (type 1) or staggered (II) heterojunctions, depending on the metal ferrite choice. These features may help lower the energy penalty of a transformation process and introduce additional selectivity and efficiency through a cooperative photocatalytic pathway. Some spinel ferrites (e.g., CoFe₂O₄) may also exhibit ferromagnetic properties that can potentially be tuned to tailor the magnetic properties of the photothermal catalyst, where, for example, a magnetic catalyst separation and recovery is desired.

Thus, described herein are example catalyst compositions for use in photothermal catalytic reactions, however, the catalyst composition may be tailored to be used in various other catalytic reactions. For example, the catalysts described herein may be used in oxidation reactions, such as degradation of organic pollutants in water and wastewater. The final catalyst product described herein may be a nanostructured material, such as a nanofiber, a nanorod, any other nano-structured material that may be produced using common electrospinning methods.

### Method of Producing

The two multi-metallic oxide technologies may have a preserved crystal structure in the composite and interact with one another to produce superior properties than those of each system taken separately. Thus, the one-pot approach electrospinning method as described herein simplifies the production process, reducing costs and improving the overall efficiency of nanofiber fabrication.

Electrospun metal oxide fibers are typically prepared by using a sacrificial organic template that is generally a spinnable polymer. The latter is removed upon heat treatment, allowing the formation of single or multi-metallic oxides. In synthesizing composites of multi-metallic oxides, controlling the fiber composition (elemental distribution), shape, and uniformity of deposition becomes very challenging when using a one-pot approach. The incompatibility of several precursors' reaction kinetics, differences in their solubility extent in the polymer solution, and processability in a single mixture complicate the deposition process, thus failing to produce the desired segregated chemistry and preserved crystal structure of targeted classes of oxides (e.g., perovskites, spinel ferrite) in a composite. For example, instead of achieving an intended composite, a one-pot approach can produce solid solutions of various metals in a single oxide system (e.g., LaFeO₃), or a heterogeneous mixture of single oxides of the parent metal ions (e.g., La₂O₃, MnO₂, Co₂O₃, and Fe₂O₃ instead of a perovskite oxide LaMnO₃ and CoFe₂O₄ spinel ferrite.

Although single-system oxide fibers have been documented for such materials by the electrospinning technique (e.g., LaMnO₃ and CoFe₂O₄, neither the mixed composite nor its one-pot synthesis approach into 1D fibers and electrospinning technique have been attempted and achieved). In cases where other relevant oxide systems have been proposed, one system is first prepared in a nanoparticle geometry, and the product formed is then used in the electrospinning solution that contains the precursors of the other system to prepare the binary composite. The latter approach is multi-step, cumbersome, time-consuming, and creates extra waste and material losses.

The hybrid catalyst's bottom-up, 1D to 3D synthesis approach aims to unlock unique physicochemical properties that are not attainable through direct bulk-scale synthesis. These include peculiar electron and heat transport along the fiber, selective surface faceting, and anisotropic defects. Therefore, the present disclosure includes shaping the hybrid perovskite oxide-spinel ferrite technology into 1D nanofibers, focusing on the one-pot electrospinning synthesis to streamline their production and reduce their manufacturing costs.

In some aspects, described herein are methods of producing the hetero-structure as described above. Specifically, the methods described herein may produce novel perovskite/spinel ferrite catalyst structures that were previously unattainable. In some embodiments, the method described herein may be in relation to an example method. The methods described herein may include alternate steps, additional steps, or the steps described herein may be ordered in an alternate order to produce. In some embodiments, the methods described herein may reduce the synthesis step to one starting mixture for electrospinning, followed by a single heat-treatment step. The one-pot approach for electrospinning simplifies the production process, reducing costs and improving the overall efficiency of nanofiber fabrication. Thus, the methods described herein, may be based on common electrospinning methods with alterations to the introduction of the multi species metal salts. Previously, multi-metallic oxide catalysts were not easily producible in a one-pot synthesis mechanism due to difficulty controlling the fiber composition (elemental distribution), shape, and uniformity of. The incompatibility of several precursors' reaction kinetics, differences in their solubility extent in the polymer solution, and processability in a single mixture complicate the deposition process, thus failing to produce the desired segregated chemistry and preserved crystal structure of targeted classes of oxides (e.g., perovskites, spinel ferrite) in a composite. For example, instead of achieving an intended composite, a one-pot approach can produce solid solutions of various metals in a single oxide system (e.g., LaFeO₃), or a heterogeneous mixture of single oxides of the parent metal ions (e.g., La₂O₃, MnO₂, Co₂O₃, and Fe₂O₃ instead of a perovskite oxide LaMnO₃ and CoFe₂O₄ spinel ferrite. Thus, the methods described herein may beneficially produce multi-metallic oxides using a one-pot solution introduction. In some embodiments, the methods may include adding additional additives for controlling the uniformity due to the reactivity of the precursors. In one non-limiting example, the titanium based precursors may be reactive and thus additional additives may be included in the method to control the reaction mixture. The additives may be known by those skilled in the arts for producing perovskite compounds from a titanium base.

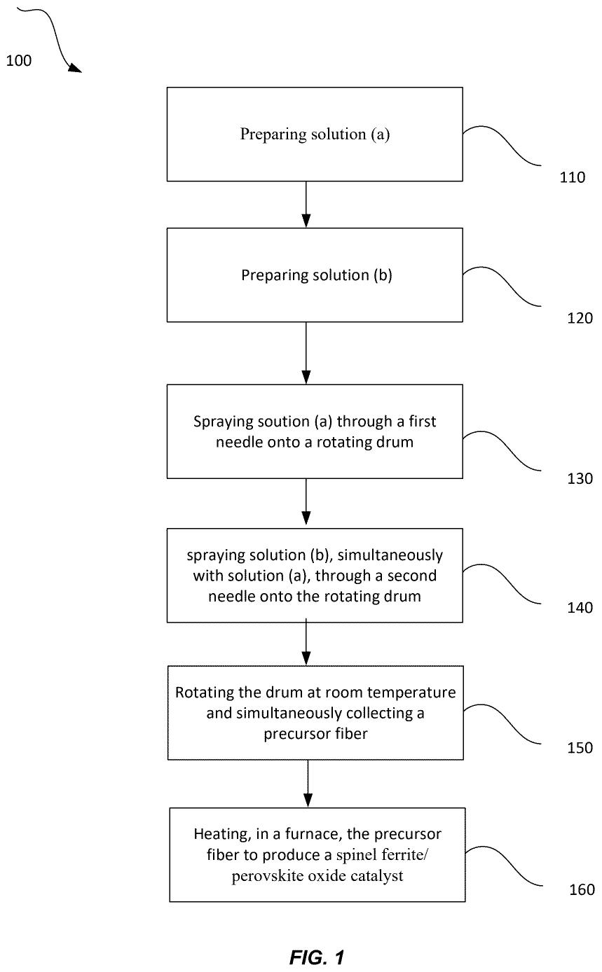

Turning now to FIG. 1, the method 100 described herein may be prepared according to the methods described herein. In a first step, the method 100 may include preparing solution (a) 110. In some embodiments, solution (a) is the core solution and may be the spinel ferrite oxide. Preparing solution (a) may include producing a first co-solvent mixture. The co-solvent mixture may be a water, methanol, and glacial acetic acid solution. In some embodiments, the ratio of water:methanol:acetic acid may be from 1:6:0.75 to 1:20:15. In some embodiments, the co-solvent solution may be produced from any combination of solvents known in the arts. In some embodiments, the solvents may be selected based at least in part on their interaction with the metals salts and polymer that may be added into the nanofiber composition.

Acetic acid may be introduced to stabilize the metal ion components of the precursor solutions, safeguarding against undesired reactions (e.g., uncontrolled salt or oxide precipitation) during solution preparation or spinning. The polymer solution viscosity, conductivity, and solvent volatility may influence the fiber diameter and size uniformity and are partly dictated by the choice of polymer and solvent system. Both methanol and de-ionized water may be used as co-solvents for the polyvinylpyrrolidone (PVP) and metal salts. Water may enhance the metal salts' solubility and control the precursor solution's viscosity.

Methanol is compatible with PVP and enables a more conductive polymer solution with better flow properties of the polymer solution under applied electrical bias compared to other organic solvents (e.g., ethanol). In some embodiments, no dripping or arching may be observed with methanol at similar polymer loading, making the spinning process adequate for upscaling. The solvent system is made rich in methanol to quickly dry the fibers upon room-temperature deposition. Fast drying is essential to prevent the remixing of the collected fibers, preserve their shape, improve their handling, and peel off from the aluminum tape substrate for further processing. Using the same base polymer/solvent mixture ensures compatibility of the two precursor spinning solutions in a coaxial electrospinning configuration without causing salt precipitation (avoiding, therefore, needle-outlet clogging).

Following the preparation of the co-solvent solution, a polymer may be added to the co-solvent system. In some embodiments, the polymer may be PVP. PVP may be selected because boasts exceptional solubility in water and various organic solvents. Its versatile nature stabilizes metal ions or particles in solutions, preventing undesired precipitation. With compatibility across a spectrum of materials, PVP proves valuable in crafting composite materials and synthesizing hybrid structures. Additionally, its film-forming properties play a crucial role in developing stable and precisely defined structures, particularly in processes like electrospinning. The PVP may be added to the co-solvent system according to Equation 1, below.

$$\% wt ( PVP ) = \frac{{mass}_{( PVP )}}{{mass}_{( PVP )} + {mass}_{( solvent mixture )} + {mass}_{( metal precursor salts )}} \times 100 \% . \qquad ( 1 )$$

In some embodiments, the final concentration of PVP in the co-solvent system may be from 1 wt. % to 25 wt. %. For example, the PVP final concentration may be from 2 wt. % to 24 wt. %, from 10 wt. % to 25 wt. %, or from 1 wt. % to 15 wt. %.

Similarly, the metal salt may be added to the polymer-co-solvent solution to produce the spinel ferrite precursor solution (a). In some embodiments, the metal salts may be acetate and nitrate salts. Acetate is expected to form a coordinate compound of metal salts with the polymer, allowing for uniform metal-ion dispersion in the precursor mixture. Sulfate salts available as alternatives are not recommended because sulfur is prone to persist as an impurity in the final material despite thermal treatment. For example, the spinel ferrite metal compounds include, but are not limited to CoFe₂O₄, NiFe₂O₄, and CuFe₂O₄. In some embodiments, the total metal moles-to-volume ratio of the total metal to co-solvent is from about 0.10 mol/L to 0.50 mol/L (e.g., 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, or 0.50 mol/L). Similarly, in some embodiments, the ratio of the total metal (A+B) moles to the volume of the co-solvent system may be maintained constant at 0.30 mol/L. In some embodiments, and as described in the examples below, the nitrate salts may be added simultaneously to produce the spinel ferrite precursor. In some embodiments, the solution (a) may include a second metal ferrite precursor salt. The second metal precursor salt and the first metal ferrite precursor salt may be included at a ratio from 1:1 to 1:5, e.g., 1:1, 1:2, 1:3, 1:4, or 1:5. In some embodiments, the solution may be produced from more than one metal precursor salt, including but not limited to iron nitrate(III) nonahydrate (Fe(NO₃)₃·9H₂O), anhydrous cobalt(II) acetate (Co(CH₃CO₂)₂), nickel(II) acetate tetrahydrate (Ni(CH₃CO₂)₂·4H₂O), and anhydrous copper(II) acetate (Cu(CH₃CO₂)₂). In some embodiments, the spinel ferrite oxide precursor solution may be produced from the iron nitrate(III) nonahydrate (Fe(NO₃)₃·9H₂O) and one other metal salt precursor. For example, solution (a) may be produced from iron nitrate(III) nonahydrate (Fe(NO₃)₃·9H₂O) and anhydrous copper(II) acetate (Cu(CH₃CO₂)₂) to produce a solution of CuFe₂O₄ precursor. In other such configurations, solution (a) precursor may be CuFe₂O₄, CoFe₂O₄, NiFe₂O₄, and Co_{0.5}Ni_{0.5}Fe₂O₄.

Following the addition of the metal salts, to solution may be stirred at room temperature for from 1 hour to 24 hours to form the ferrite-PVP composite precursor solution. For example, the solution may be stirred for 1 to 24 hours, e.g., from 5 to 24 hours, from 10 to 24 hours, from 15 to 24 hours, from 20 to 24 hours, from 1 to 20 hours, from 1 to 15 hours, from 1 to 10 hours, or from 1 to 5 hours. In some embodiments, the solution may be heated. In scenarios in which heating is applied to the solution, the solution may be stirred for less than 2 hours.

At step 120, solution (b) is prepared in a separate reaction. Specifically, to produce solution (b), a similar solvent base mixture is prepared as solution (a). Following the production of the co-solvent system, the predetermined amount of PVP may be added to the co-solvent to produce the PVP-co-solvent mixture. In some embodiments, the final concentration of PVP may be the same as the addition to solution (a). For example, the PVP may be added according to Equation 1. The PVP may dissolve into the co-solvent solution for producing an homogenous mixture. To the homogenous mixture, the metal salt precursors may be added. For example, solution (b) may be produced to include the transition metal perovskite as described in the examples section below. In some embodiments, the solutions are subsequently mixed to fully dissolve the acetate precursor.

Following the addition of the metal salts, to solution may be stirred at room temperature for from 1 hour to 24 hours to form the perovskite-PVP composite precursor solution. For example, the solution may be stirred for 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, or 24 hours. In some embodiments, the solution may be heated. In scenarios in which heating is applied to the solution, the solution may be stirred for less than 2 hours.

In some embodiments, the acetate precursors may not adequately dissolve under the conditions described above. Thus, to the PVP-co-polymer solution may include the addition of an acid. In some embodiments, the acid may be a strong mineral acid including but not limited to nitric acid, sulfuric acid, hydrochloric acid, or citric acid. In some embodiments, the acid may be a 10M aqueous HNO₃ solution to aid in reducing the pH. The addition of the acid may reduce the pH of the solution to at or below 5, at or below 4, at or below 3, or at or below 2, to aid in dissolving the metal salts.

The method 100 may include an additional step of spraying 130 solution (a) through a first needle onto a rotating drum. Similarly, the method 100 includes an additional step of spraying 140 solution (b) through a second needle onto the rotating drum. The method 10 described herein may include spraying solution (a) and solution (b) simultaneously onto the rotating drum. For example, the system may be configured to include the two needles positioned concentrically to one another. The concentric needles may include a first needle (the core needle) positioned in an inner diameter of a second needle. The needles may be any diameter suitable to perform the actions described herein. For example, the needle size and diameter may be adjusted depending on the size of the experiment being performed. In some embodiments, the methods described herein may be performed on an industrial level whereby the size and diameter of the needles may be larger than described herein. In some non-limiting examples, the first needle may be a 24-gauge needle and the second needle may be an 18-gauge needle. The 24-gauge needle may have an inner diameter of 0.311 mm and an outer diameter of 0.566 mm while the 18-gauge needle may have an inner diameter of 0.838 mm.

Solution (a) and solution (b) may be sprayed at a rate of from 0.2 mL/h up to 3 mL/h. For example, the system may include pumps such as pneumatic syringe pumps, or any other pump system for pushing liquids through a system. The solution may be introduced as described above, at a rate of from 0.2 mL/h up to 3 mL/h (e.g., from 0.5 mL/h to 2.5 mL/h, from 0.2 mL/h to 2.0 mL/h, or from 0.4 mL/h to 1.5 mL/h).

In some embodiments, the needles as described above, may be positioned a distance away from the rotating drum to create a mixing region in a space positioned between the needle tip and the rotating drum. For example, the needles may be placed from 1 cm to 30 cm away from the rotating drum. For example, the tip to drum distance may be from 1 cm to 30 cm (e.g., from 1 cm to 25 cm, from 5 cm to 25 cm, from 10 cm to 25 cm, from 15 cm to 30 cm, or from 5 cm to 15 cm).

Similarly, the system may include a configuration including a high voltage supply. The high voltage supply may be electrically configured to the concentric needles to produce an electrically charged spray leaving the needle tip. For example, the high voltage supply may introduce a positive voltage to the needle tips while the rotating drum is grounded. The positive voltage may be from 1 kV to 30 kV. For example, the voltage may be from 1 kV to 30 kV (e.g., 5 kV to 30 kV, from 10 kV to 30 kV, from 5 kV to 25 kV, from 5 kV to 20 kV, or from 10 kV to 20 kV).

In some embodiments, while the solutions are sprayed onto the drum, the drum may be rotating at a rate to produce fibers along the outer surface of the rotating drum. The drum may rotate at a rate from 100 RPM to 2000 RPM. For example, the drum may rotate from 100 RPM to 2000 (e.g., from 400 RPM to 1800 RPM, from 800 RPM to 1600 RPM, or from 1000 RPM to 1200 RPM). In some embodiments, the drum may rotate at a rate of from 1000 RPM to 1500 RPM. In some embodiments, the rotation of the drum may be increased or decreased depending on the spraying speed of the solutions as described above.

The rotating drum may include a thin layer of aluminum tape configured around the rotating drum and positioned to collect the fibers. The aluminum tape may be removed from the drum after each batch of the fibers is produced and replaced.

In some embodiments, the rotating drum is maintained at room temperature to produce the precursor fibers. The precursor fibers may be subsequently peeled off of the drum and placed into a furnace and heated 160 to calcinate the fibers and produce the spinel ferrite/perovskite oxide catalyst. For example, the furnace may be heated to a temperature of from 300° C. to 800° C. In some embodiments, the furnace be heated to from 300° C. to 800° C. (e.g., from 400° C. to 800° C., from 500° C. to 800° C., from 600° C. to 800° C., or from 700° C. to 800° C.)

### Methods of Use

In some embodiments, the methods described herein may produce a heterostructure for use in catalyzing a reaction. The method may include adding, to a reaction, the catalyst as described above. In some embodiments, the method further includes applying light to the reaction that includes the catalyst for a period of time to sufficiently increase the temperature of the reaction. The light source selected may be at a wavelength that overlaps with a bandgap of the catalyst. In one non-limiting example, the CoFe₂O₄/LaMnO₃ heterostructure may have a bandgap corresponding to 855 nm wavelength. Thus, the wavelengths of light used may be a wavelength corresponding to the IR spectral range. In some embodiments, the light source may be a 250 W IR lamp.

In some embodiments, the configuration of the system for catalyzing the reaction may include a steady gas flow inlet, a reaction chamber, a temperature detection area via a thermocouple, and an exhaust gas port. The reaction chamber may include an introduction area for the heterostructure. In some embodiments, the reaction chamber may be maintained at a temperature range of from 25° C. to 200° C. (e.g., 50° C. to 150° C., or 100° C. to 200° C.). In some embodiments, the injector temperature may be maintained in a range of from 100° C. to 200° C. In some embodiments, the injector temperature was maintained at 150° C. The injections may be performed in split mode at a 20:1 split ratio. In some embodiments, the oven temperature program may begin at 80° C. followed by holding for 2 minutes and subsequently ramping at 20° C./min to a final temperature of 230° C. The final temperature may be sustained for 2 minutes. This time frame to reach the final temperature and maintain a final temperature may be about 11 minutes and 50 seconds. In some embodiments, the system may include a detector, including but not limited to a flame ionization detector (FID). The FID may be operated at a set point of 250° C. The system may be configured to include a bubbling system to bubble a liquid solvent and produce a gas stream. The gas stream may be produced with zero air and subsequently diluted to reach an initial concentration of 2,000 parts per million by volume (ppmᵥ).

In some embodiments, the methods described herein may result in a conversion rate of from 50% to 100% when used in a continuous flow system. For example, the method may result in a 50% to 100% (e.g., from 60% to 100%, from 70% to 100%, from 80% to 100%, or from 90% to 100%) conversion.

In some embodiments, the catalyst described herein may maintain a crystal structure for an extended period of time or across multiple catalytic cycles. For example, the crystal structure of the heterostructure may be maintained for from 1 hour to 20 hours (e.g., 1 hour to 20 hours, from 5 hours to 20 hours, from 10 hours to 20 hours, or from 15 hours to 20 hours) of consecutive cycling time.

In some embodiments, the catalyst described herein may be used in photothermal catalysis optoelectronics, gas sensing, catalysis, electrochemical fuel cells, and battery electrode configurations. Similarly, the combined system as described herein may be used in heterogeneous catalysis, photocatalysis, photothermal catalysis, and electrocatalysis.

### EXAMPLES

### Example 1: Preparation of the Fiber Precursors

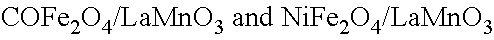

Solution A was prepared by combining 25 mL of water, 150 mL of methanol, and 15 mL of glacial acetic acid to produce a co-solvent system. To the co-solvent system was added 23.31 g of polyvinylpyrrolidone (PVP). The solution was mixed to form a homogenous mixture described as a hydro-organic polymer solution. Subsequently, 15.00 g of iron nitrate (Fe(NO₃)₃9H₂O) and 5.40 g of nitrate salt (Co(NO₃)₂·6H₂O) to produce a Co/Fe ratio of 1:2, were added to the PVP solution. The subsequent mixture was stirred magnetically at room temperature for 24 hours to form the cobalt ferrite-PVP composite precursor solution, referred to herein as solution A.

For solution A using the Ni precursor, the solution was prepared in a similar fashion to solution A above. Briefly, to a PVP-solvent solution was added 15.00 g of iron nitrate (Fe(NO₃)₃·9H₂O) and 4.60 g of acetate salt (Ni(CH₃CO₂)₂·4H₂O) to produce a Ni/Fe mol ratio of 1:2. The subsequent mixture was magnetically stirred for 24 hours to produce the nickel ferrite-PVP composite precursor solution.

To produce solution B, a similar solvent solution was prepared as described above. Briefly, A base solvent mixture of water, methanol, and acetic acid (5:30:3) was prepared. To the solution was added 8.70 g La(CH₃CO₂)₃₋xH₂O and 6.74 g Mn(CH₃CO₂)₂·4H₂O, corresponding to a 1:1 mol ratio of the constituent metal elements (i.e. La/Mn) and 0.30 mol/L loading. A calculated amount of 22.63 g of PVP (equivalent to 12 wt % in the final mixture) was dissolved in the co-solvent system, followed by adding the metal salt precursors. The resulting blend was stirred at room temperature for 24 hours. To fully dissolve the acetate precursors, a few drops of 10 M aqueous HNO₃ are added to the mixture to lower the pH to 1.5.

For the reported materials, either of the ferrite precursor polymer solution A, as described above in relation to cobalt and nickel) was dispensed through a 0.4 mm inner diameter stainless-steel needle. The lanthanum manganite precursor polymer solution B was delivered though another stainless-steel needle of 0.6 mm inner diameter. Both needles were fitted within a coaxial spinneret, forming a concentric arrangement where the narrower needle is used as a core. The synthesis is also reproduced by delivering solution A through a 24-gauge core needle with an inner diameter of 0.311 mm and an outer diameter of 0.566 mm. Simultaneously, solution B was fed through an 18-gauge sheath needle of 0.838 mm inner diameter. Solutions A and B were prepared according to the methods described above.

The concentric needles were connected to a high-voltage supply (18 kV) with a fixed core needle tip-to-fiber collector working distance of 15 cm. Solution A and solution B were supplied at 0.5 mL/h using pneumatic syringe pumps. The fibers were collected on aluminum tape mounted on a rotating drum rotating at 1200 rotations per minute (RPM). The electrospinning synthesis of multiple batches of the above-mentioned composites was done with precursor solutions prepared on different dates to check the batch-to-batch repeatability. Some batches were also produced from the same precursor solution used on other days to check the temporal stability of the composites.

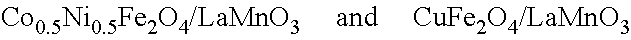

Solutions A and B were prepared according to the methods described above. Briefly, to produce solution A 14.63 g of PVP was dissolved in a 5:30:3 (v/v/v) solvent mixture consisting of water (15 mL), methanol (90 mL), and glacial acetic acid (9 mL), respectively. 9.09 g of iron nitrate(III) nonahydrate (Fe(NO₃)₃·9H₂O), 1.00 g anhydrous cobalt(II) acetate (Co(CH₃CO₂)₂) and 1.381 g nickel(II) acetate tetrahydrate (Ni(CH₃CO₂)₂·4H₂O) were incorporated into the above polymer solution. The masses were adjusted to the net volume of solvent used to achieve a fixed ratio of the total metal (M+Fe) moles-to-the volume of the co-solvent system (0.30 mol/L) and a final PVP content of 12 wt %. The masses of Co and Ni precursors ensure a stoichiometric balance of 1:2 mol ratio of [Co+Ni] to Fe. Cobalt and nickel precursor salts having a common anion (e.g., acetate) were used when preparing the Co_{0.5}Ni_{0.5}Fe₂O₄ precursor solution to enhance the system's compatibility. Maintaining a common anion also facilitates a homogeneous substitutional distribution of Co and Ni ions in the ferrite structure to prevent the formation of segregated CoFe₂O₄ and NiFe₂O₄ particles. After the metal salts were loaded, the precursor mixture was stirred magnetically at room temperature for 24 hours.

To produce the copper solution A, 9.75 g of PVP was first dissolved in a mixture of water (10 mL), methanol (60 mL), and glacial acetic acid (6 mL), giving a 5:30:3 volume ratio. Then, 6.00 g of iron(III) nitrate nonahydrate (Fe(NO₃)₃·9H₂O) and 1.35 g anhydrous copper(II) acetate (Cu(CH₃CO₂)₂) were added to the hydro-organic polymer mixture. The final mixing step follows the above-reported protocol.

Similar fabrication steps to the ones described above were used to produce the fibers. Briefly, solution A was delivered through a 24-gauge needle (0.311 mm inner diameter/0.566 mm outer diameter). Solution B, consisting of the polymer composite precursor mixture of the perovskite oxide, was supplied through an 18-gauge sheath needle (0.838 mm inner diameter). During coaxial spinning, the concentric needles were connected to a high-voltage source supplied with 18 kV for spinning the precursor fibers of Co_{0.5}Ni_{0.5}Fe₂O₄/LaMnO₃ and 16 kV for those of CuFe₂O₄/LaMnO₃. The core needle tip-to-collector distance was maintained at 15 cm. both solutions were dispensed at a rate of 1 mL/h using pneumatic syringe pumps to increase the yield. The electrospun fibers were collected on aluminum tape mounted on a rotating drum operating at 1200 rpm.

Following the production of the precursors on the aluminum tape, the polymer residues were heat treated to produce the crystalline phases of perovskites. Initial trials were conducted at 600° C. and led to insufficient crystallinity. Through further experimentation, it was determined that spinning the fibers and heat treating at an initial temperature of 80° C. for 5 hours followed by peeling the dried material from the substrate. The subsequent fiber substrate was calcinated in a furnace at 700° C. for 2 hours with a heating rate of 2° C./min. Described in more detail below were additional experiments performed on determining a calcification temperature for the CuFe₂O₄/LaMnO₃ spinel ferrite/perovskite oxide nanofibers.

### Example 2: Structural Analysis Using p-XRD and TEM

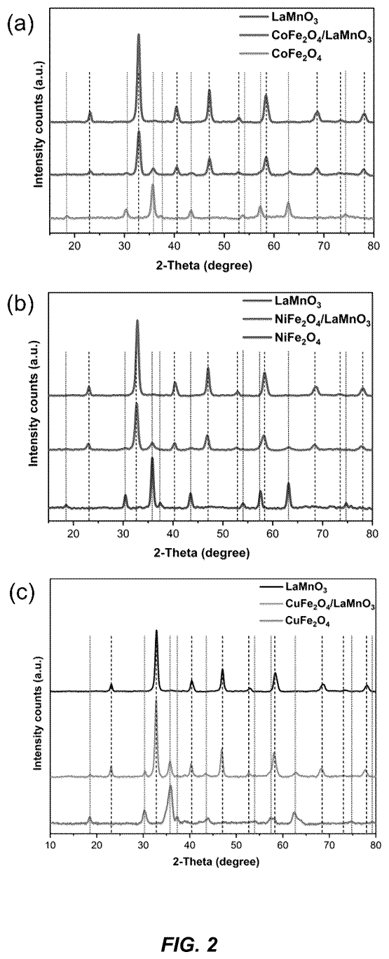

The powder x-ray diffraction (pXRD) technique is essential as a key phase analysis method, facilitating the determination of interactions between the spinel ferrite and perovskite oxide components. The first evidence of the co-presence of preserved spinel ferrites (MFe₂O₄; where M=Co, Ni, or Cu) and lanthanum manganite (LaMnO₃) phase structures in the composite nanofibers was confirmed through their p-XRD patterns versus those of the control single system nanofibers (FIG. 2). The X-ray excitation source was Cu-Kα. As demonstrated in FIG. 2 the precursor spinel ferrites and perovskites precursors were conserved in the nanofiber composite materials. For example, in (a), the lanthanum manganite precursor peaks are represented by the dotted lines while the CoFe₂O₄ precursor peaks are represented by the solid lines. Similarly, in (b) and (c) the lanthanum manganite peaks are represented by the dotted lines and the spinel ferrite precursor peaks are the solid lines.

The discernment of the spinel ferrite (MFe₂O₄) and LaMnO₃ phase in the p-XRD patterns of the composites (with no measurable impurity) was consistent with the following reference cards of the single oxide systems found in the joint committee on powder diffraction standards (JCPDS) database: #22-1086 (cubic CoFe₂O₄), #01-074-2081 (cubic NiFe₂O₄), #770100 (cubic CuFe₂O₄), and #320484 (rhombohedral LaMnO₃), as per the indexed diffraction peak data shown in Table 1.

TABLE 1
Mapped p-XRD diffraction peaks of spinel-ferrite/lanthanum manganite
nanofibers prepared via the methods described herein.
CoFe₂O₄/LaMnO₃

| Indexed Phase: | Exp. 2Theta (°) | 18.58 | 30.24 | 35.78 | 37.24 | 43.81 | 54.03 | 57.54 | 63.19 | |
|---|---|---|---|---|---|---|---|---|---|---|
| Cubic CoFe₂O₄ | Indexed planes | (111) | (220) | (311) | (222) | (400) | (422) | (511) | (440) | |
| (JCPDS: #221086) | | | | | | | | | | |
| Indexed Phase: | Exp. 2Theta (°) | 23.19 | 32.92 | 40.53 | 47.04 | 52.91 | 58.44 | 68.62 | 73.50 | 77.90 |
| Rhombohedral | Indexed planes | (012) | (110) | (104) | (202) | (024) | (122) | (214) | (220) | (208) |
| LaMnO₃ (#320484) | | | | | | | | | | |

NiFe₂O₄/LaMnO₃

| Indexed Phase: | Exp. 2Theta (°) | 18.75 | 30.65 | 35.84 | 37.47 | 43.46 | 54.09 | 57.67 | 63.25 | |
|---|---|---|---|---|---|---|---|---|---|---|
| Cubic NiFe₂O₄ | Indexed planes | (111) | (220) | (311) | (222) | (400) | (422) | (511) | (440) | |
| (JCPDS: #01-074-2081) | | | | | | | | | | |
| Indexed Phase: | Exp. 2Theta (°) | 23.06 | 32.72 | 40.34 | 46.91 | 52.80 | 58.28 | 68.48 | 73.32 | 77.64 |
| Rhombohedral | Indexed planes | (012) | (110) | (104) | (202) | (024) | (122) | (214) | (220) | (208) |
| LaMnO₃ (#320484) | | | | | | | | | | |

CuFe₂O₄/LaMnO₃

| Indexed Phase: | Exp. 2Theta (°) | 18.57 | 30.28 | 35.80 | 37.34 | 43.72 | 53.54 | 57.51 | 62.50 | |
|---|---|---|---|---|---|---|---|---|---|---|
| Cubic CuFe₂O₄ | Indexed planes | (111) | (220) | (311) | (222) | (400) | (422) | (511) | (440) | |
| (JCPDS: #770100) | | | | | | | | | | |
| Indexed Phase: | Exp. 2Theta (°) | 23.05 | 32.70 | 40.28 | 46.82 | 52.85 | 58.20 | 68.36 | 73.33 | 77.84 |
| Rhombohedral LaMnO₃ | Indexed planes | (012) | (110) | (104) | (202) | (024) | (122) | (214) | (220) | (208) |
| (JCPDS: #320484) | | | | | | | | | | |

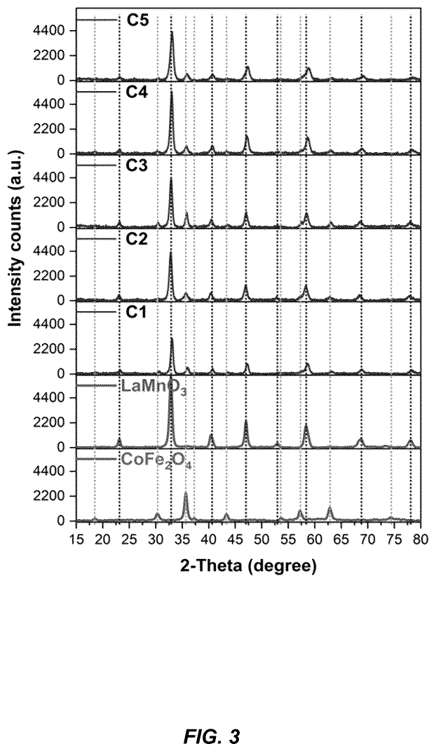

Similarly, FIG. 3 illustrates example p-XRD patterns for five different samples of CoFe₂O₄/LaMnO₃ composite fibers (C1-C5) and respective controls. The dashed green reference lines are associated with the characteristic diffraction peak positions of the CoFe₂O₄ phase, while the blue lines inform that of the LaMnO₃. The X-ray excitation source was Cu-Kα. The patterns of the single oxides LaMnO₃ and CoFe₂O₄ are reproduced from FIG. 2 for visual aid. As can be discerned from the p-XRD patterns, all the samples exhibited the combined characteristic diffraction peaks of the control single oxides, confirming the co-presence of the two-systems in the composites.

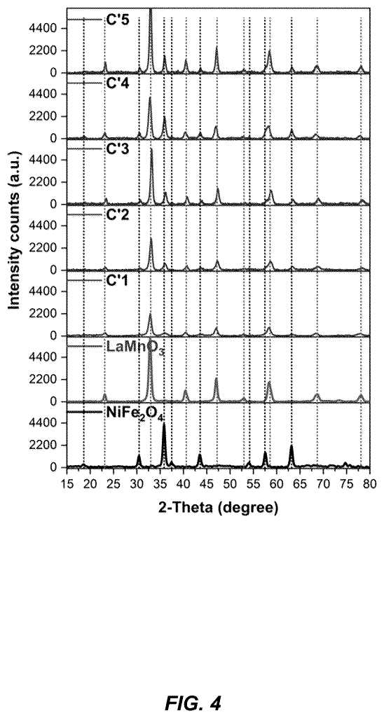

Turning to FIG. 4, the p-XRD patterns of NiFe₂O₄/LaMnO₃ composite fibers randomly sampled from five (5) different batches demonstrated the co-presence of the ferrite and perovskite oxide phases in the composite. These results were in agreement with Table 1 results, above. The black dashed lines refer to the characteristic diffraction peak positions of the NiFe₂O₄ phase, while the blue lines inform those of the LaMnO₃. The X-ray excitation source was Cu-Kα. The single oxides LaMnO₃ and NiFe₂O₄ patterns are reproduced from FIG. 2 for visual aid.

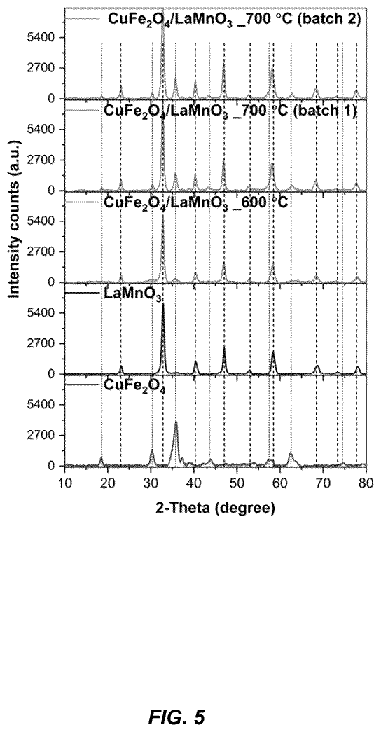

Additionally, p-XRD patterns of CuFe₂O₄/LaMnO₃ fibers post-calcination at 600° C. and 700° C. were prepared (FIG. 5). The diffraction patterns of the control oxides are reproduced from FIG. 2 for visual aids. Conditions. X-ray excitation source: Cu-Kα. Collectively, the p-XRD patterns observed in FIG. 3-FIG. 5 demonstrate the co-presence of the ferrite and perovskite oxide phases in the composition. The results demonstrate that the method described herein can produce multi-metal oxide catalysts for use in photothermal catalysis methods.

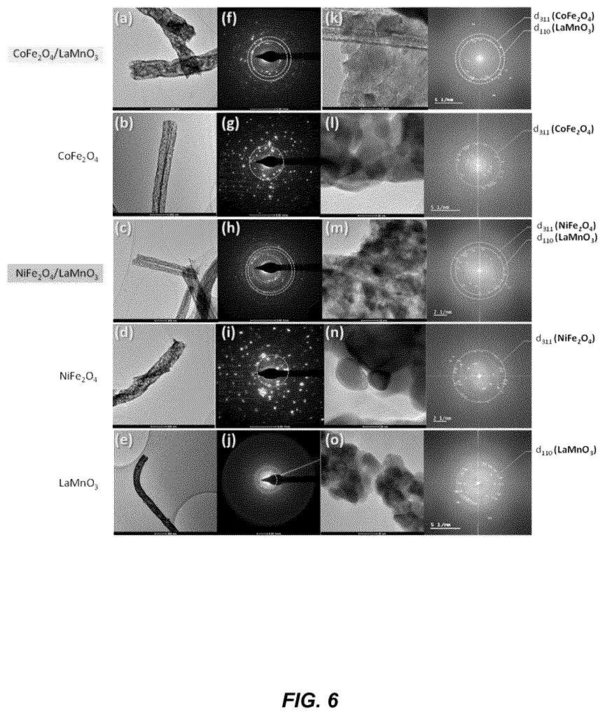

The method described herein is a co-axial electrospinning, one-pot synthesis method. The two systems mix the fibers and form hollow or core-shell nanofiber structures. These observations are evidenced by the high-resolution bright-field transmission electron microscopy images of the composites versus those of control samples, as shown in FIG. 6(a-e). The phase structures identified in the p-XRD results discussed above are further corroborated by the crystal plane indexing results from the selected area electron diffraction patterns (FIG. 6 (f-j)). The complementary fast Fourier transformation (FFT) analyses of high magnification TEM images are shown in FIG. 6(k-o) evidence the co-presence of neighboring nanocrystallites of spinel ferrites and lanthanum manganite perovskite. These results are a first indication of the possible interfacial interactions through the formation of nano-heterojunctions between the two different phases.

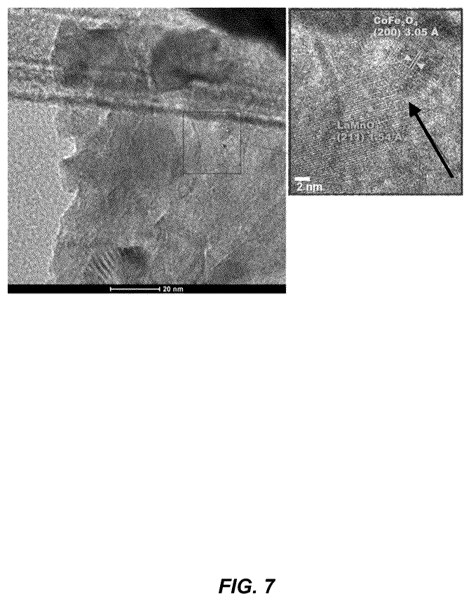

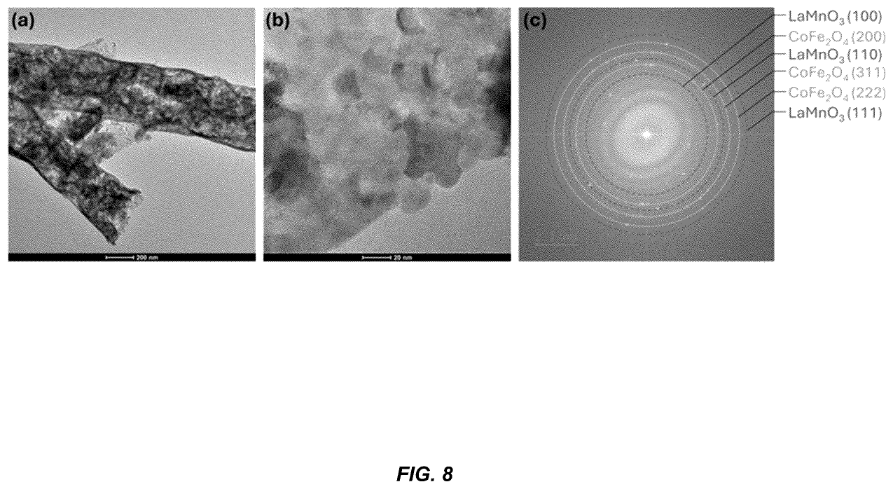

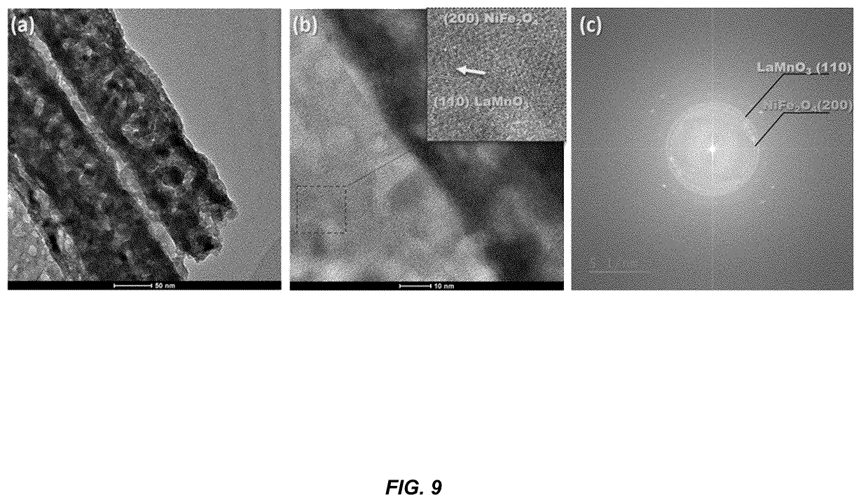

Further analysis using bright field transition electron microscopy confirmed the interface between the CoFe₂O₄ and LaMnO₃ crystallites in the CoFe₂O₄/LaMnO₃ composite fiber (FIG. 7). Analysis of the lattice spacing in the CoFe₂O₄ (200) was 3.05 Angstrom, while the LaMnO₃ (211) was 1.54 Angstrom. TO further confirm the co-presence of the two crystalline phases CoFe₂O₄ and LaMnO₃ in the hollow composite fiber, random samples from replicate batches were analyzed using TEM (FIG. 8). The bright-field TEM and FFT analysis further confirmed the co-presence of the CoFe₂O₄ and LaMnO₃ by their indexed planes. Similar experiments of the NiFe₂O₄/LaMnO₃ composite fiber specimen sampled from a reproduced batch confirmed the co-presence of the two species in the fiber (FIG. 9).

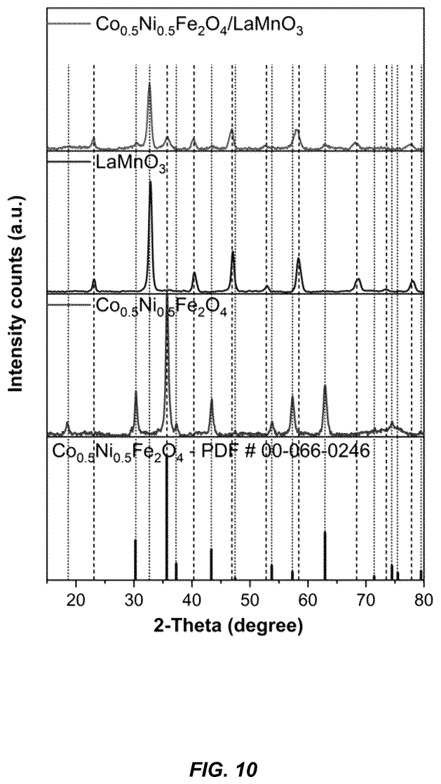

Fibers were similarly produced using a hybrid spinel ferrite species, as described in Example 1, above. P-XRD was similarly performed on the hybrid fibers and compared to the controls and reference mixed ferrite system. The p-XRD patterns may be found in FIG. 10. The JCPDS pattern for the mixed ferrite phase Co_{0.5}Ni_{0.5}Fe₂O₄ was reported as a reference. X-ray excitation source: Cu-Kα. The Y-axis scale was similar across the three experimental patterns. The discernment of the spinel ferrite and LaMnO₃ phases in the p-XRD patterns of the composites was consistent with the following reference cards of the single oxide systems found in the Joint Committee on Powder Diffraction Standards (JCPDS) database: #00-066-0246 (cubic Co_{0.5}Ni_{0.5}Fe₂O₄), and #320484 (rhombohedral LaMnO₃), as per the indexed diffraction peak data shown in Table 2.

TABLE 2
Mapped pXRD patterns of Co_{0.5}Ni_{0.5}Fe₂O₄/LaMnO₃ fibers.
Co_{0.5}Ni_{0.5}Fe₂O₄/LaMnO₃

| | | | | | | | | | | |
|---|---|---|---|---|---|---|---|---|---|---|
| Indexed Phase: | Experimental 2Theta (°) | 30.30 | 35.65 | 37.30 | 43.43 | 47.44 | 53.73 | 57.30 | 62.91 | 75.52 |
| Cubic Co_{0.5}Ni_{0.5}Fe₂O₄ | Indexed planes | (220) | (311) | (222) | (400) | (331) | (422) | (511) | (440) | (622) |
| (JCPDS: 00-066-0246) | | | | | | | | | | |
| Indexed Phase: | Experimental 2Theta (°) | 23.06 | 32.64 | 40.30 | 46.88 | 52.64 | 58.11 | 68.13 | 73.33 | 77.57 |
| Rhombohedral LaMnO₃ | Indexed planes | (012) | (110) | (104) | (202) | (024) | (122) | (214) | (220) | (208) |
| (JCPDS: #320484) | | | | | | | | | | |

To confirm the substitutional mixing of Co and Ni cations in Co_{0.5}Ni_{0.5}Fe₂O₄ and Co_{0.5}Ni_{0.5}Fe₂O₄/LaMnO₃ as opposed to forming independent CoFe₂O₄ and NiFe₂O₄ crystallites, the lattice parameter of the mixed systems was calculated and compared to those of the control ferrites produced experimentally. The calculated lattice parameters using the resolved peak corresponding to the distinct diffraction plane (440) are provided in Table 3 for comparison purposes. The lattice parameter of Co_{0.5}Ni_{0.5}Fe₂O₄ in the single oxide fiber (8.3463 Å) and the composite material (8.3519 Å) is within the range defined by the pure NiFe₂O₄ and CoFe₂O₄ phases [8.3199-8.3587 Å], confirming the substitutional mixing between Co and Ni ions, and thus, solid solution formation in Co_{0.5}Ni_{0.5}Fe₂O₄.

TABLE 3
Estimated p-XRD cubic lattice parameter for the
Co_{0.5}Ni_{0.5}Fe₂O₄ phase in the single-oxide fibers and
Co_{0.5}Ni_{0.5}Fe₂O₄/LaMnO₃ composite fibers.

| | | | Lattice |
|---|---|---|---|
| | XRD-2θ | | Parameter, |
| Material | (°) | XRD-d₄₄₀ | a (Å) |
| Co_{0.5}Ni_{0.5}Fe₂O₄ fiber | 62.944 | 1.4754 | 8.3463 |
| Co_{0.5}Ni_{0.5}Fe₂O₄/ | 62.897 | 1.4764 | 8.3519 |
| LaMnO₃ fiber | | | |
| Co_{0.5}Ni_{0.5}Fe₂O₄ | 62.940 | 1.4755 | 8.3468 |
| (JCPDS: 00-066-0246) | | | |
| CoFe₂O₄ fiber | 62.840 | 1.4776 | 8.3587 |
| NiFe₂O₄ fiber | 63.167 | 1.4708 | 8.3199 |

### Example 3. Morphology and Elemental Distribution Analysis of Composite Fibers

Scanning Electron Microscopy (SEM)-Elemental X-Ray Dispersive Spectroscopy (EDX) of MFe₂O₄/LaMnO₃ (where, M=Co, Ni or Cu) Fibers

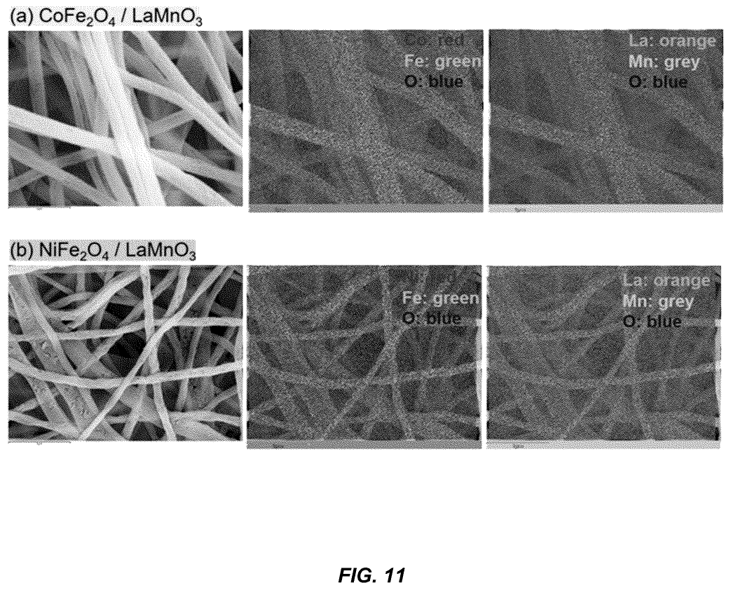

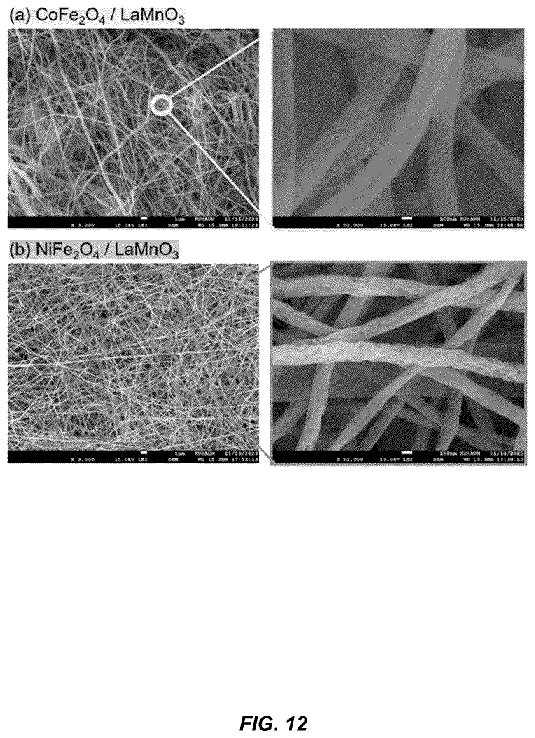

Scanning electron microscopy-elemental x-ray dispersive spectroscopy mapping was performed on the nanofiber composites produced via the methods described above to better ascertain the structural composition. The SEM-EDX mapping, as shown in FIG. 11, demonstrated the co-presence of uniformly distributed systems within the individual fibers. For example, as shown in FIG. 11, the Ni, Co, Fe, O, La, and Mn elements were observed as evenly distributed throughout the entirety of the nanofibers. Similarly, as observed in FIG. 12, the nanofibers produced were randomly oriented having a diameter of a few hundred nanometers across with a surface texture that depends on the nature of the metal ferrite system used. For example, the CoFe₂O₃ presented with a different surface texture as compared to the NiFe₂O₃ nanofiber composite, as observed in FIG. 12.

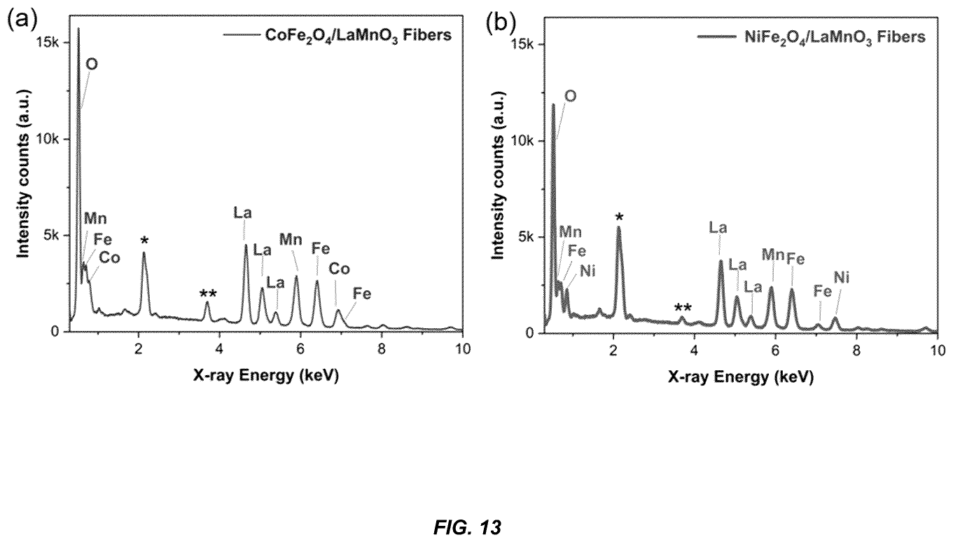

The semi-quantitative EDX analysis of the fibers (FIG. 13) confirmed the presence of the constituent elements of the metal ferrites and lanthanum manganite at similar atomic compositions to those used in the preparation of the starting precursor mixtures of each system. As seen in FIG. 13, *Au X-ray peak is observed at 2.1 keV due to sample sputtering with gold before imaging. ** Sn X-ray peak is found at 3.7 keV in all sample spectra and originates from the SEM sample holder. These were found at approximately 2:1 (M/Fe) where M=Co or Ni for the spinel ferrite components and 1:1 (La/Mn) for the lanthanum manganite components, indicating the successful elemental yield of the co-axial electrospinning synthesis methodology. The atomic ratios are shown in Table 4, below.

TABLE 4
Atomic ratios for composite materials.

Atomic Ratios

| Composites | M:Fe | La:Mn | (M + Fe)/(La + Mn) |
|---|---|---|---|
| CoFe₂O₄/LaMnO₃ | 2.01:1 | 0.99:1 | 0.81:1 |
| NiFe₂O₄/LaMnO₃ | 2.02:1 | 0.99:1 | 0.84:1 |

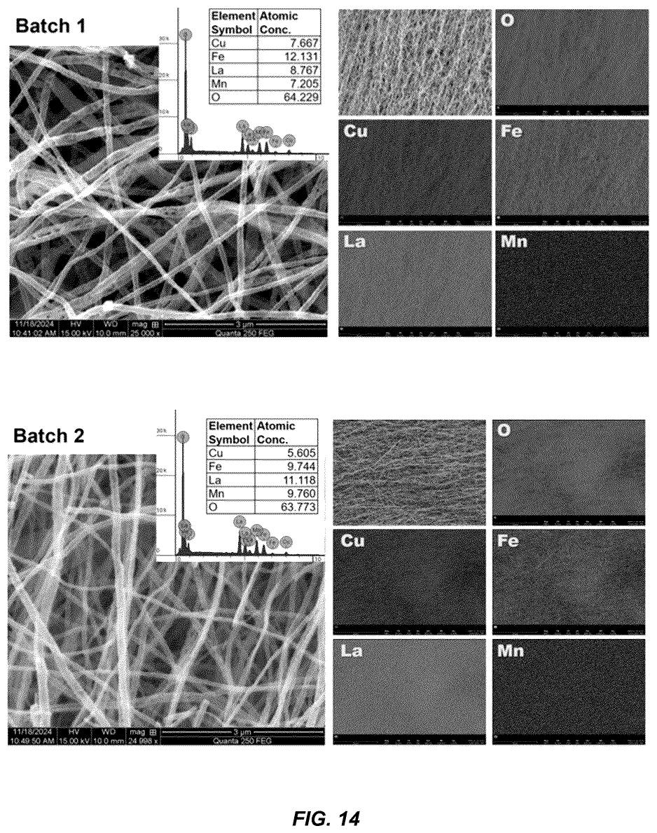

Analysis of two separate batches of CuFe₂O₄/LaMnO₃ composite fibers demonstrated similar fiber shape and microscopic textures. The semi-quantitative EDX analysis and elemental mapping data confirmed the presence of the constituent elements with uniform atomic dispersion across the tested specimens (FIG. 14). For example, Batch one's atomic concentration of Cu was 7.667%, Fe was 12.131%, La was 8.767%, Mn was 7.205%, and O was 64.229%. Similarly, the Batch two concentrations were 5.605% Cu, 9.744% Fe, 11.118% La, 9.760% Mn, and 63.773% 0. Taken collectively, these results demonstrate the reproducibility of the nanofibers using the methods described herein for preparing the catalysts. Specifically, the results demonstrate the novel one-pot electrospinning of ferrite/perovskite oxide can produce stable nanofibers for use in catalytic reactions for energy harvesting and conversion.

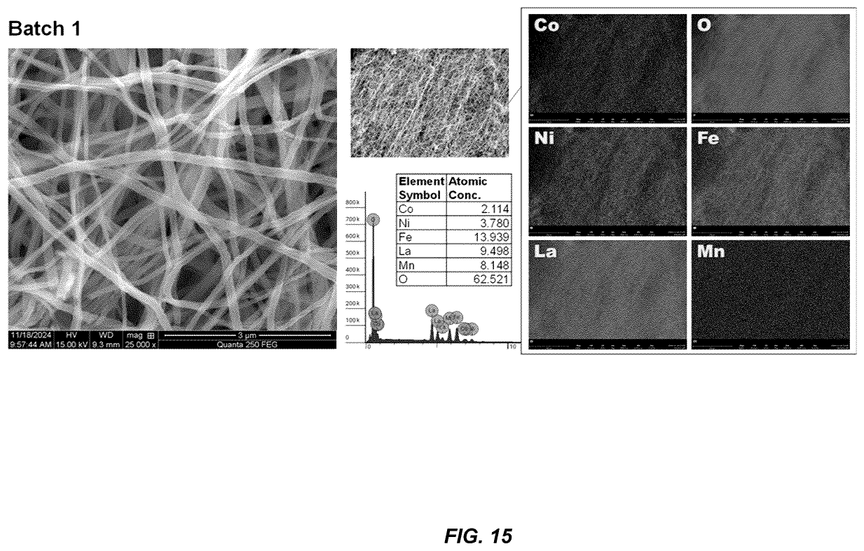

Turning now to the hybrid composite nanofibers, SEM-EDX analysis was performed to assess the elemental composition and simultaneously image the fibers as prepared. As observed in FIG. 15, the material displayed a porous nanofibrous structure with uniform elemental distortion. The semi-quantitative EDX analysis confirmed the presence of both Co and Ni. However, due to convoluted characteristics, X-ray peaks for Co and Ni at the energy range of 7-8 kV, the atomic ratio of Co:Ni was not reliably determined from EDX analysis. A distribution of fibers was observed that was consistent with the multi-metallic nanofibers described above. For example, the fibers present under SEM were uniform in shape and length. The elemental composition demonstrated a concentration of 2.114% Co, 3.780% Ni, 13.939% Fe, 9.498% La, 8.148% Mn, and 62.521% 0.

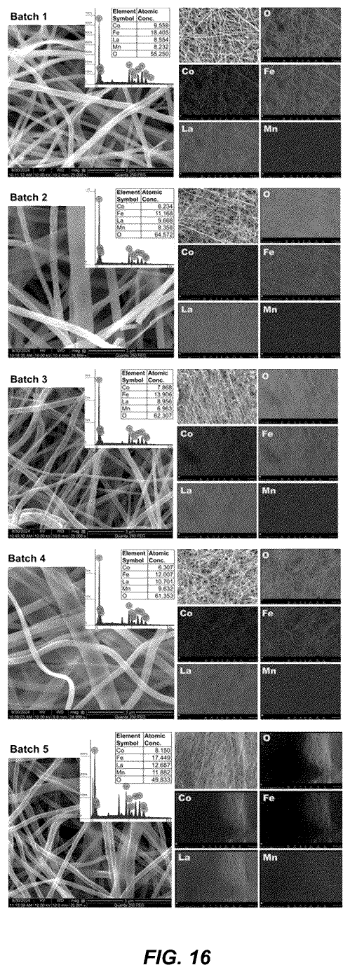

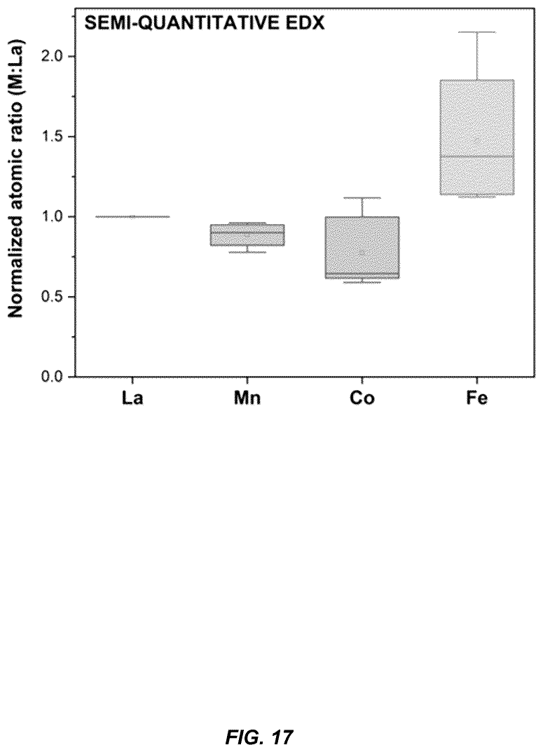

To assess the batch to batch reproducibility of the methods described herein, 5 independent replicate batches were assessed via similar SEM-EDX analysis (FIG. 16). The EDX spectra of FIG. 16 all demonstrated a similar pattern to that of FIG. 13. The spectra demonstrated the presence of oxygen and the four key metal elements used in the proposed fiber technology: La, Mn, Co, and Fe. The semi-quantitative EDX analysis of the metals (normalized to that of La) is shown in FIG. 17 and the corresponding descriptive statistics data are summarized in Table 5, below. Specifically, in FIG. 17, semi-quantitative EDX analysis of the average metal (M) composition in CoFe₂O₄/LaMnO₃ fibers using five batches (N=5) was analyzed. The box plots show the mean normalized atomic ratio (M:La), median value, and lower/upper quartiles per element. The whiskers indicate the minimum and maximum values obtained from the five reported batches. The semi-quantitative nature of the method is partly because the analytical depth of EDX (e.g., collected X-ray signal intensities) can vary with the deposited sample topography and microscale thickness. Thus, a complete analysis of the material may not be determined via EDX alone to ascertain a complete elemental analysis. The results as demonstrated by Table 5, demonstrate a relative 1:1 correlation of element M to La for Mn, Co, and Fe across all 5 batches.

TABLE 5
Descriptive Statistics (one-way ANOVA) for
the EDX Results of CoFe₂O₄/LaMnO₃ Fibers

| | No. of | Mean | Standard | Standard Error (SE) |
|---|---|---|---|---|
| Element | batches (N) | (M:La) | Deviation (SD) | of Mean (α = 0.05) |
| La | 5 | 1 | 0 | 0 |
| Mn | 5 | 0.888 | 0.072 | 0.032 |
| Co | 5 | 0.775 | 0.222 | 0.099 |
| Fe | 5 | 1.471 | 0.419 | 0.187 |

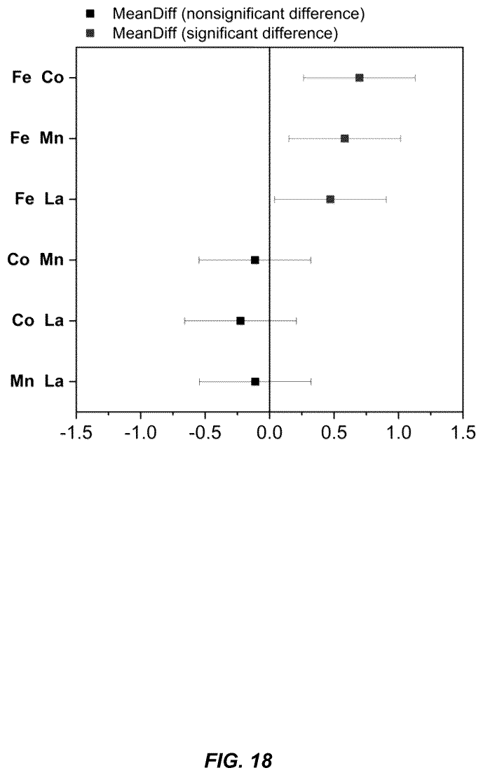

Further analysis of the comparison of means for M:La, based on one-way ANOVA with the Tukey test (α=0.05) was evaluated (FIG. 18). The test confirmed a similar content for La, Co, and Mn (e.g., no statistically meaningful difference) for the five examined batches and a consistently different content for Fe. Theoretically, the iron atomic content is double compared to each of the other elements (La, Co, and Mn), as anticipated from the formula of the composite CoFe₂O₄/LaMnO₃. The estimated average ratio Co:Fe (0.775:1.471) from Table 5 was about 1:1.9, which is very close to the set value of 1:2. Since the estimated mean atomic ratio La:Mn:Co is close to 1:1:1 (no statistically meaningful difference), it may be estimated that the formula ratio between the cobalt ferrite (CoFe₂O₄) and perovskite (LaMnO₃) phases evidenced from XRD and TEM data is 1:1 (i.e., 50/50). Comparison of means results are summarized in Table 5, below. As observed in Table 6, there was a significant difference in the contents of Fe:La, Fe:Mn, and Fe:Co. While I the ratio of Mn:La, Co:La, and Co:Mn were not significantly different.

TABLE 6
Tukey Test for the comparison of the mean atomic
ratios (M:La) in CoFe₂O₄/LaMnO₃ fibers.

| | | Standard | | | | | | |
|---|---|---|---|---|---|---|---|---|
| | | Error of | | | | | | |
| | MeanDiff | Mean | q Value | Prob | Alpha | Sig | LCL | UCL |
| Mn La | −0.112 | 0.152 | 1.04348 | 0.880 | 0.05 | 0 | −0.545 | 0.322 |
| Co La | −0.225 | 0.152 | 2.10446 | 0.467 | 0.05 | 0 | −0.659 | 0.208 |
| Co Mn | −0.114 | 0.152 | 1.06097 | 0.875 | 0.05 | 0 | −0.547 | 0.320 |
| Fe La | 0.471 | 0.152 | 4.39939 | 0.031 | 0.05 | 1 | 0.038 | 0.905 |
| Fe Mn | 0.583 | 0.152 | 5.44287 | 0.007 | 0.05 | 1 | 0.150 | 1.017 |
| Fe Co | 0.697 | 0.152 | 6.50384 | 0.002 | 0.05 | 1 | 0.263 | 1.130 |

Prob: probability;
Sig: significant;
LCL: lower control limit;
UCL: upper control limit

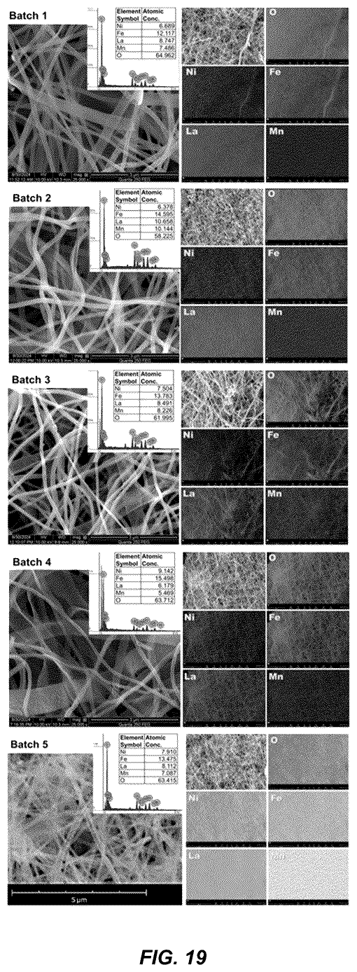

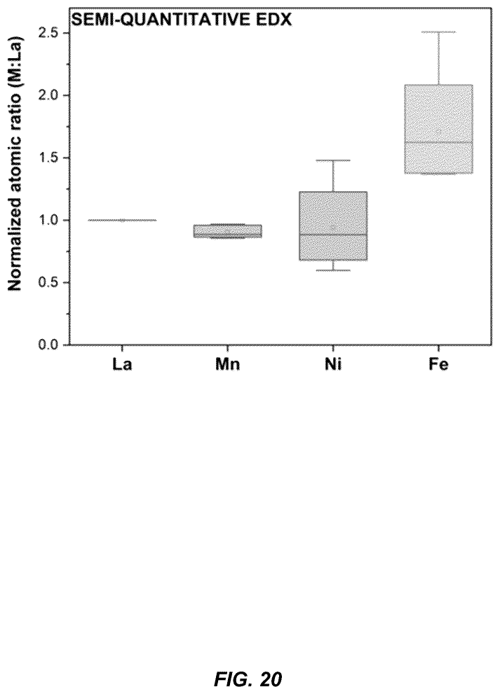

Similar analysis was performed on replicate batches (N=5) of NiFe₂O₄/LaMnO₃ fibers. The SEM-EDX analysis of the 5 batches demonstrated as similar fiber structure as the composite nanofibers described above (FIG. 19). The EDX patterns observed in all 5 batches were similar to the EDX patterns of FIG. 13(b), confirming the reproducibility of the method described herein to produce the composite fibers using the Ni precursor spinel ferrite. The semi-quantitative EDX analysis of the metals in NiFe₂O₄/LaMnO₃ fibers was normalized to that of La and is shown in FIG. 20. The box plots show the mean normalized atomic ratio (M:La), median value, and lower/upper quartiles per element. The whiskers indicate the minimum and maximum estimated values from the five reported batches. The descriptive analysis is prepared in Table 7, below.

TABLE 7
Descriptive Statistics (one-way ANOVA) for
the EDX Results of NiFe₂O₄/LaMnO₃ Fibers

| | No. of | Mean | Standard | Standard Error (SE) |
|---|---|---|---|---|
| Element | batches (N) | (M:La) | Deviation (SD) | of Mean (α = 0.05) |
| La | 5 | 1 | — | — |
| Mn | 5 | 0.907 | 0.050 | 0.022 |
| Ni | 5 | 0.940 | 0.333 | 0.149 |
| Fe | 5 | 1.709 | 0.466 | 0.208 |

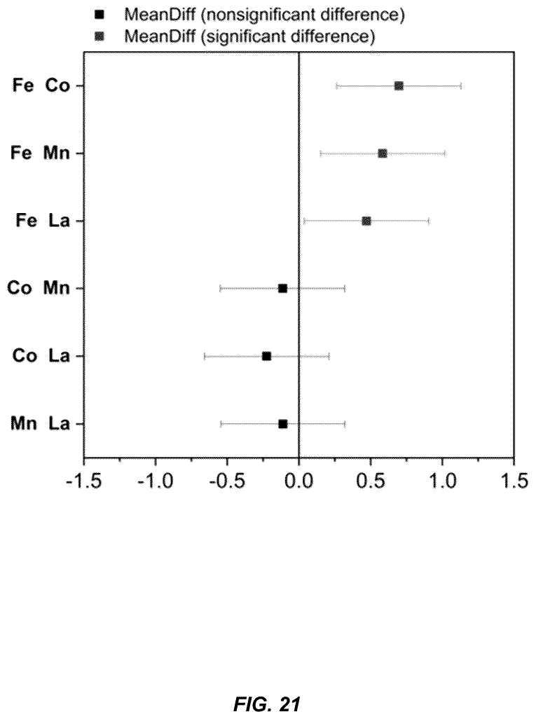

Further analysis of the comparison of means for M:La, based on one-way ANOVA with the Tukey test (α=0.05) was evaluated (FIG. 21). The results were in agreement with the findings for the cobalt ferrite-based system (Table 6), the semi-quantitative EDX analysis of NiFe₂O₄/LaMnO₃ fibers demonstrated an equivalent content of La, Ni, and Mn in the five examined batches and a statistically different content for Fe. According to the formula unit of the composite (NiFe₂O₄/LaMnO₃), the atomic ratio of iron is double that of Ni, La, or Mn. The estimated experimental mean ratio Ni:Fe (=0.940:1.709) from Table 6 is ≈1:1.8, which is close to the theoretical value of 1:2. Additionally, the estimated elemental ratio La:Mn:Ni is close to 1:1:1, confirming that the formula ratio between the nickel ferrite (NiFe₂O₄) and the perovskite oxide (LaMnO₃) phases is 1:1 (i.e., 50/50). The results from the Tukey test are summarized in Table 8, below. As can be seen from the results, a similar trend was observed for the NiFe₂O₄/LaMnO₃ nanofiber composite as was seen with the nanofiber composite above. Specifically, there was a significant difference in the ratio of Fe to La, Mn, and Ni, while no significant difference was observed for the La to Mn, Ni, or Ni:Mn.

TABLE 8
Tukey test for the comparison of the mean atomic
ratios (M:La) in NiFe₂O₄/LaMnO₃ fibers.

| | | Standard | | | | | | |
|---|---|---|---|---|---|---|---|---|
| | | Error of | | | | | | |
| | MeanDiff | Mean | q Value | Prob | Alpha | Sig | LCL | UCL |
| Mn La | −0.093 | 0.182 | 0.72341 | 0.955 | 0.05 | 0 | −0.613 | 0.427 |
| Ni La | −0.060 | 0.182 | 0.46448 | 0.987 | 0.05 | 0 | −0.580 | 0.460 |
| Ni Mn | 0.033 | 0.182 | 0.25893 | 0.998 | 0.05 | 0 | −0.487 | 0.553 |
| Fe La | 0.709 | 0.182 | 5.52014 | 0.006 | 0.05 | 1 | 0.189 | 1.229 |
| Fe Mn | 0.802 | 0.182 | 6.24355 | 0.002 | 0.05 | 1 | 0.282 | 1.322 |
| Fe Ni | 0.769 | 0.182 | 5.98462 | 0.003 | 0.05 | 1 | 0.249 | 1.289 |

Prob: probability;
Sig: significant;
LCL: lower control limit;
UCL: upper control limit

### Example 3: Analysis of Textural Properties of the Nanofiber Composites

The pore structure plays a crucial role in determining the performance of heterogeneous catalysts. To assess the textural properties of the samples, liquid nitrogen adsorption/desorption isotherms were measured at 77 K using a Micromeritics Tristar II Plus apparatus, an automatic specific surface area analyzer. Before physisorption measurements, the samples were degassed at 200° C. for 5 hours under dynamic vacuum conditions. The specific surface area was determined using the Brunauer-Emmett-Teller (BET) method, within a relative pressure (P/Po) range of 0.049 to 0.299. Pore size distribution analysis was performed using the Barrett-Joyner-Halenda (BJH) method on the desorption isotherm.

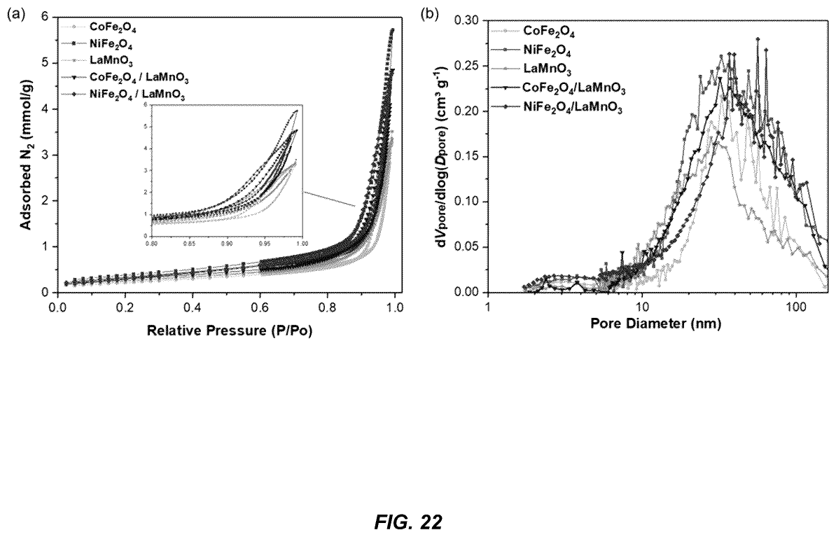

As shown in FIG. 22 (a), the liquid N₂ adsorption-desorption isotherms of the synthesized catalysts exhibit a Type IV isotherm with mixed H1 and H4 hysteresis loops, confirming a mesoporous texture with the co-existence of cylindrical and slit-shaped pore geometries. All materials demonstrated a broad mesopore size distribution as shown in FIG. 22 (b). Table 9 summarizes the calculated specific surface area (S_{BET}), total pore volume, and pore diameter values for the reported catalysts. The single and heterostructured oxide fibers demonstrate close S_{BET} values irrespective of their composition. The noticeable increase and decrease in the total pore volume/average pore diameter values of the composite fibers versus their control single oxides confirm the interaction between the metal ferrite (MFe₂O₄) and perovskite phases in the binary systems. The results demonstrate that such interaction may be dependent on the nature of the metal (M) cation (Ni²⁺/Co²⁺) in the ferrite phase, suggesting different diffusion dynamics of these cations in the electrospinning polymer solution during fiber deposition, and subsequently in the solid fiber during the conversion of the polymer composite network into oxide by calcination treatment. Such difference could be induced by the nature of the counter anion (acetate or nitrate) available in the nickel and cobalt salt precursors, where the counter anion, polarity, acid-base, and ligand exchange properties may influence the extent of metal ion-organic polymer network interaction in addition to the electrospinning spinning solution conductivity.

TABLE 9
Textural properties of the investigated nanofiber samples.

| | S_{BET} | Total pore volume, | Average pore |
|---|---|---|---|
| Catalysts | (m²/g) | Vₚₒᵣₑ (cm³/g) | diameter, Dₚₒᵣₑ (nm) |
| CoFe₂O₄ | 22.2 | 0.114 | 20.53 |
| NiFe₂O₄ | 26.8 | 0.199 | 29.68 |
| LaMnO₃ | 22.3 | 0.122 | 21.89 |
| CoFe₂O₄/LaMnO₃ | 26.9 | 0.168 | 25.04 |
| NiFe₂O₄/LaMnO₃ | 28.1 | 0.166 | 23.70 |

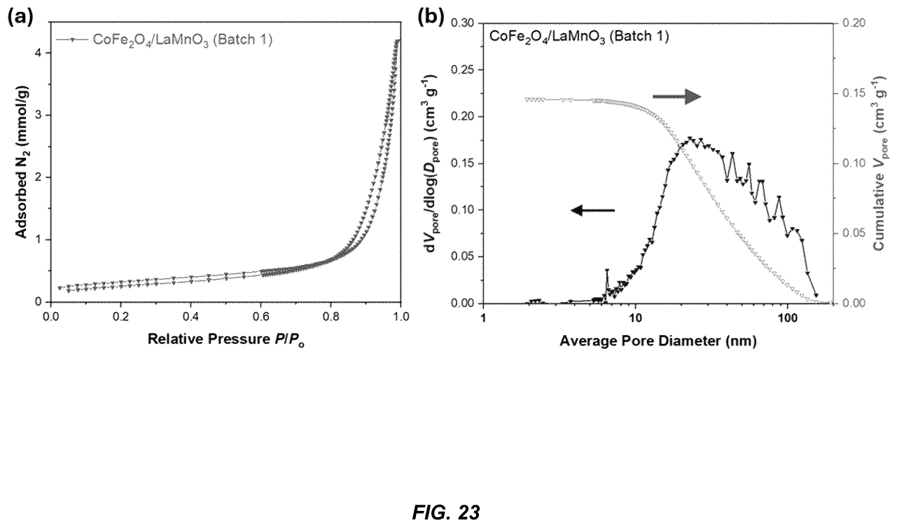

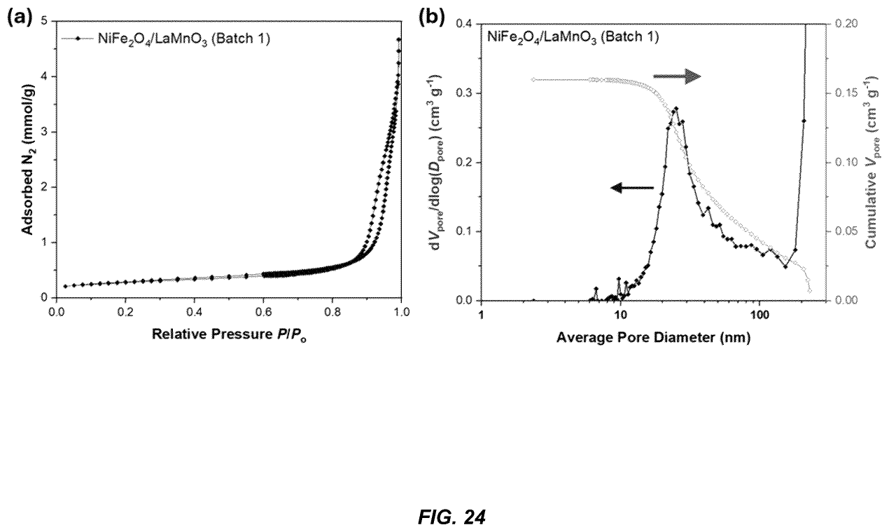

Similarly, isotherms were prepared for CoFe₂O₄/LaMnO₃ (FIG. 23). The liquid N₂ adsorption-desorption isotherms (77 K) for CoFe₂O₄/LaMnO₃ sampled from batch 1 and its corresponding BJH pore size distribution analysis plot were in agreement with Table 9. The occurrence of a hysteresis loop in the high relative pressure range of the isotherm profiles demonstrates the presence of large pores in the material, which are confirmed in the pore size distribution plot. The tested sample has an estimated surface area (S_{BET}) of 25.4 m²/g, a mesoporous texture with an average pore diameter of 22.97 nm, and total pore volume (at P/Pₒ 0.99) of 0.146 cm³/g. Additional isotherms prepared from NiDe₂O₄/LaMnO₃ composite nanofibers. (FIG. 24). Specifically, liquid N₂ adsorption-desorption isotherms (77 K) for a sample of NiFe₂O₄/LaMnO₃ nanofibers collected from its corresponding batch 1, along with the resulting BJH pore size distribution analysis plot demonstrate results in agreement with Table 9. The adsorption isotherms of this sample exhibit a hysteresis loop in the high relative pressure range (P/P₀>0.8) indicating the presence of large pores in the material. According to the isotherm data and pore size distribution plot, the analyzed sample has an estimated surface area (S_{BET}) of 22.7 m²/g, a mesoporous texture with an average pore size of 28.58 nm, and a total pore volume of 0.162 cm³/g (at P/Pₒ 0.99).

### Analysis of the Chemical Surface States

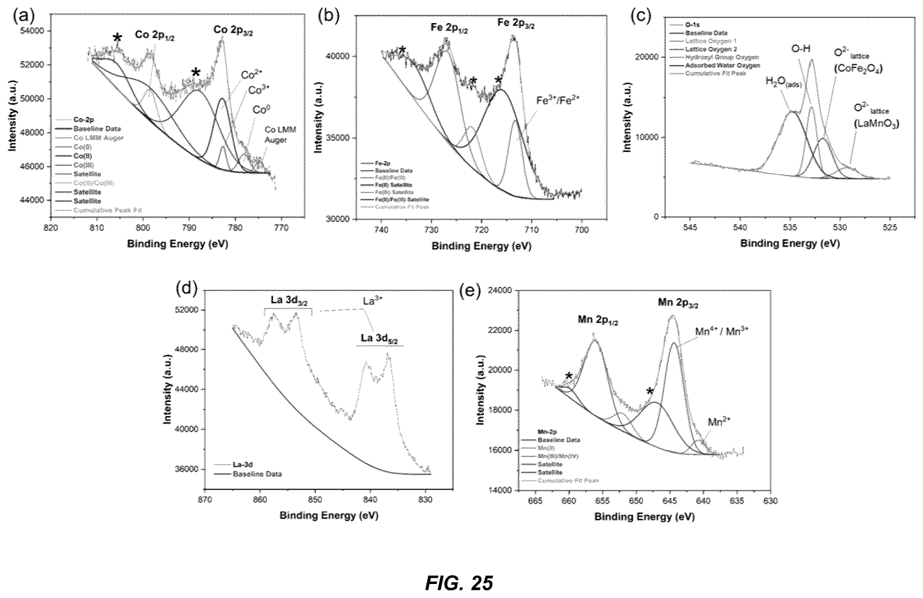

To better understand the compositional makeup of the nanofiber composites, vacuum XPS was performed on single batches of each corresponding nanofiber. FIG. 25 (a-e) illustrates the characteristic vacuum XPS features of CoFe₂O₄/LaMnO₃ heterocomposite fibers. The broad characteristic electron binding energy peak of cobalt in the Co 2p_{3/2} region at 782.8 eV (FIG. 25 (a)) and the broad satellite feature near 786 eV suggest the copresence of Co⁰, Co²⁺ and Co³⁺ in the spinel ferrite structure. The occurrence of multiple oxidation states for cobalt could be attributed to the presence of oxygen vacancies in the spinel structure and the partial exchange of cations between the octahedral and tetrahedral sites. According to FIG. 25 (b), the existence of iron ions in the two oxidation states (+2 and +3) confirms their distribution across the tetrahedral and octahedral sites in agreement with the iron occupancies in an inverse spinel structure. The characteristic XPS features of La and Mn in the La-3d and Mn-2p regions, respectively, evidence the presence of La(III), whereas manganese ions occur in +2/+3/+4 oxidation states. Without being bound by any theory, it is hypothesized that the multiple charge states for manganese could be attributed to the high oxygen mobility in the lanthanum manganite lattice.

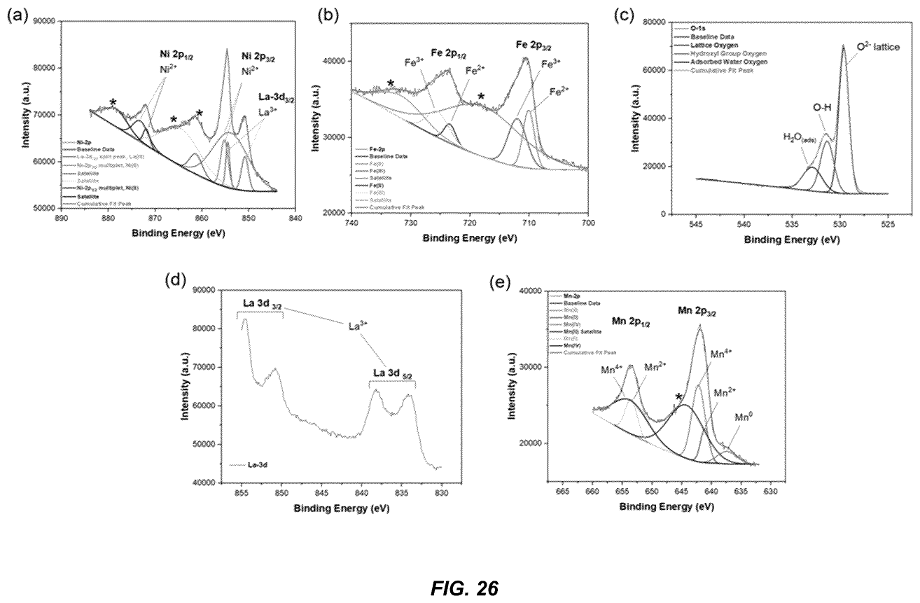

Similarly, FIG. 26 (a-e) illustrates the characteristic vacuum core XPS features of NiFe₂O₄/LaMnO₃ heterocomposite fibers. In FIG. 26(a), the electron energy binding positions of Ni-2p and La-3d were considered during the mapping due to the partial overlapping of the characteristic features of the two elements. Unlike cobalt, Ni adopts a single (+2) oxidation state in the spinel ferrite component, which is further evidenced by the presence of multiplet satellite features. According to FIG. 26(b), the area ratio of Fe³⁺ and Fe²⁺ is estimated at 1.33, suggesting the formation of a partially inversed spinel structure. The XPS electron binding energy features for the lattice oxygen in the O-1s profile of NiFe₂O₄/LaMnO₃ fibers (FIG. 26 (c)) appeared different from those of the CoFe₂O₄/LaMnO₃ heterocomposites, highlighting differences in the surface interactions among each two oxides. The presence of different oxidation states for manganese is another confirmation of the high oxygen mobility in LaMnO₃.

### Analysis of Optical Absorption Properties

The optical energy bandgap (Eg) of the control and hetero-composite fibers was estimated from UV-vis-near IR diffuse reflectance spectroscopy (UV-vis-NIR DRS) measurements, coupled with the Tauc plot method and Kubelka-Munk function for data analysis based on the following Equations (2) and (3):

$${[ F ( {R}_{∞} ) \times hv ]}^{\frac{1}{n}} = A ( hv - {E}_{g} ) \qquad ( 2 )$$

where; n=2 for an indirect allowed electronic transition, A is a fitting constant, hv is the incident photon energy in electron-volt (eV), and F(R_{∞}) is the Kubelka-Munk function based on the diffuse reflectance (R_{∞}) parameter, which is proportional to the absorption coefficient (a) and inverse of the scattering coefficient (S) of the absorbing material through the equation below:

$$F ( {R}_{∞} ) = \frac{{( 1 - {R}_{∞} )}^{2}}{2 {R}_{∞}} \approx \frac{α}{S} \qquad ( 3 )$$

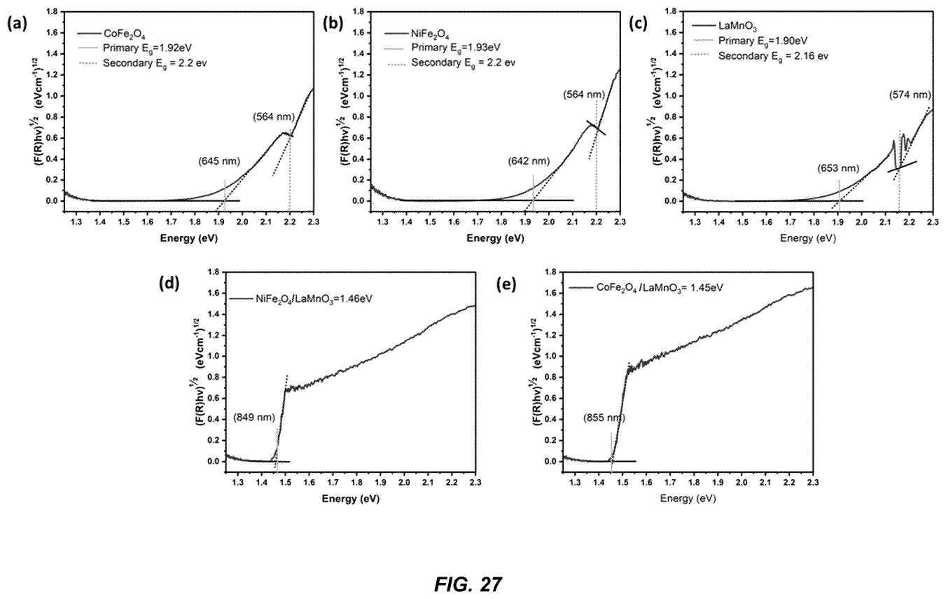

FIG. 27 (a-e) shows that the estimated indirect-bandgap values of controls and heterocomposites (1.4-2.2 eV) lie within the visible and near infra-red range (i.e., 400 nm-1000 nm), which confirms the suitability of these materials for applications involving solar/visible light energy harvesting. Interestingly, the bandgap energy values for the two heterocomposite spinel ferrite/lanthanum manganite systems (FIG. 27 (d-e)) are red-shifted toward the near-IR energy range compared to those of the individual components (FIG. 27 (a-c)). It is believed this shift could be attributed to synergetic interfacial interactions arising from the formation of nano-heterojunctions between the spinel ferrite and lanthanum manganite particles.

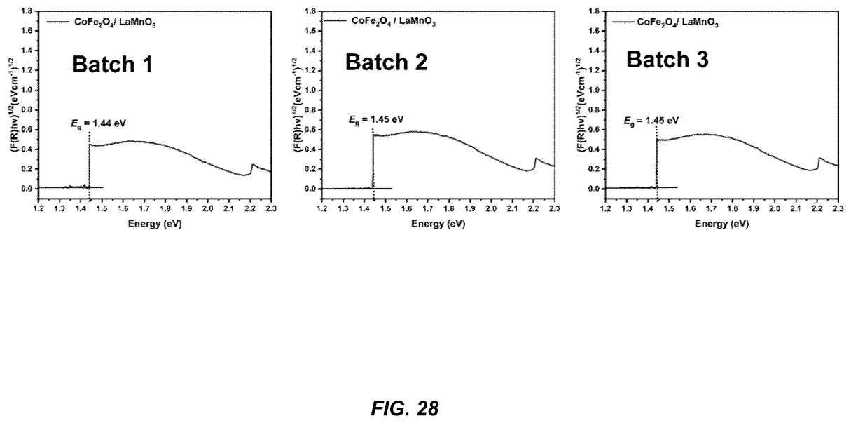

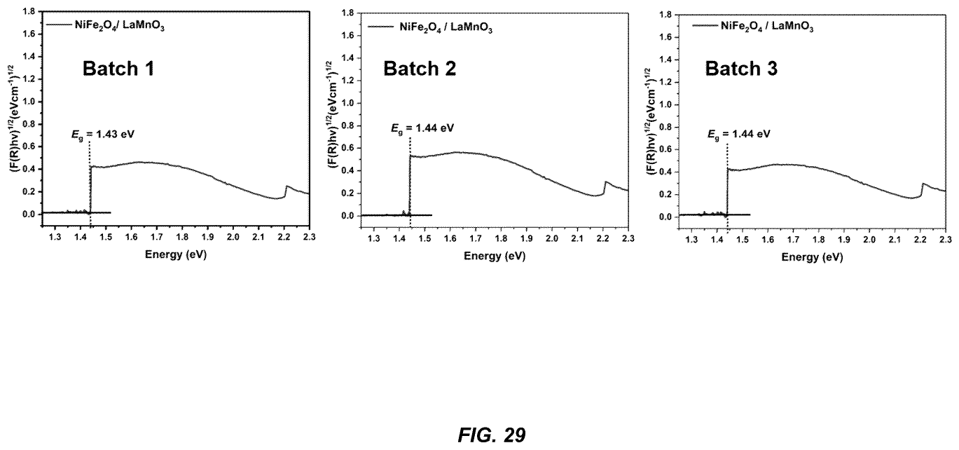

The UV-vis DRS analysis of three random samples of CoFe₂O₄/LaMnO₃ composite fibers (FIG. 28) demonstrate a consistent indirect bandgap value of about 1.44-1.45 eV, which corresponds to the near IR range (855-861 nm) and agrees with the findings reported in FIG. 27. Thus, the results demonstrate a reproducible nanofiber composite using the methods described herein. Similarly, according to the UV-vis DRS analysis shown in FIG. 29, three random samples of NiFe₂O₄/LaMnO₃ composite fibers demonstrate a consistent indirect bandgap value of about 1.43-1.44 eV, which corresponds to the near IR range (861-867 nm).

### Analysis of Band-Edge by XPS/UV-Vis-NIR-DRS

Heterojunctions manifested by two interfacing semiconductors can be generally classified into three fundamental structures: (i) straddling gap (type-I), (ii) staggered gap (type-II, Z-scheme, or S-scheme), and (iii) broken gap (type-III). To identify which type of heterojunction is likely formed in each spinel ferrite/lanthanum manganite composite, the analysis of the conduction band (CB) and valence band (VB) offsets from XPS vacuum core and XPS valence band spectral data was performed and used in conjunction with the UV-vis-NIR DRS results reported in FIG. 27 (a-c). The valence band discontinuity (e.g., valence band offset, ΔE_{V}) at the interface (i) between two semiconductors X and Y was calculated according to the general Equation (4) below:

$$Δ {E}_{V ( interface )} = ( {E}_{core}^{Y} - {E}_{VBM}^{Y} ) - ( {E}_{core}^{X} - {E}_{VBM}^{X} ) - ( {E}_{core}^{i , Y} - {E}_{core}^{i , X} ) \qquad ( 4 )$$

where

$$( {E}_{core}^{Y} - {E}_{VBM}^{Y} )$$

is the electron binding energy difference between the highest occupied core level and valence band maximum (VBM) level in the control semiconductor Y;

$$( {E}_{core}^{X} - {E}_{VBM}^{X} )$$

refers to the electron binding energy difference between the highest occupied core level and valence band maximum level in the control semiconductor X;

$$( {E}_{core}^{i , Y} - {E}_{core}^{i , X} )$$

is the electron binding energy difference between the highest occupied core levels of semiconductor X and semiconductor Y in the composite.

The following Equations (5) and (6) for the valence band offset can be written for the spinel ferrite/lanthanum manganite composites reported in this work, assuming Y=LaMnO₃ and X=spinel ferrite:

$$Δ {E}_{V ( {CoFe}_{2} {O}_{4} / {LaMnO}_{3} )} = ( {E}_{core - Mn 3 p}^{{LaMnO}_{3}} - {E}_{VBM}^{LaM {nO}_{3}} ) - ( {E}_{core - Co 3 p}^{{CoFe}_{2} {O}_{4}} - {E}_{VBM}^{{CoFe}_{2} {O}_{4}} ) - ( {E}_{core - Mn 3 p}^{{CoFe}_{2} {O}_{4} / {LaMnO}_{3}} - {E}_{core - Co 3 p}^{{CoFe}_{2} {O}_{4} / {LaMnO}_{3}} ) \qquad ( 5 )$$

$$Δ {E}_{V ( {NiFe}_{2} {O}_{4} / {LaMnO}_{3} )} = ( {E}_{core - Mn 3 p}^{{LaMnO}_{3}} - {E}_{VBM}^{{LaMnO}_{3}} ) - ( {E}_{core - Fe 3 p}^{{NiFe}_{2} {O}_{4}} - {E}_{VBM}^{{NiFe}_{2} {O}_{4}} ) - ( {E}_{core - Mn 3 p}^{{NiFe}_{2} {O}_{4} / {LaMnO}_{3}} - {E}_{core - Fe 3 p}^{{NiFe}_{2} {O}_{4} / {LaMnO}_{3}} ) \qquad ( 6 )$$

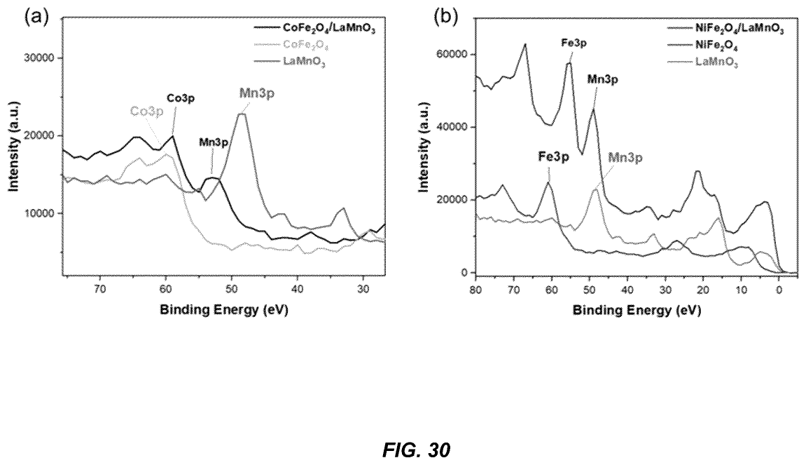

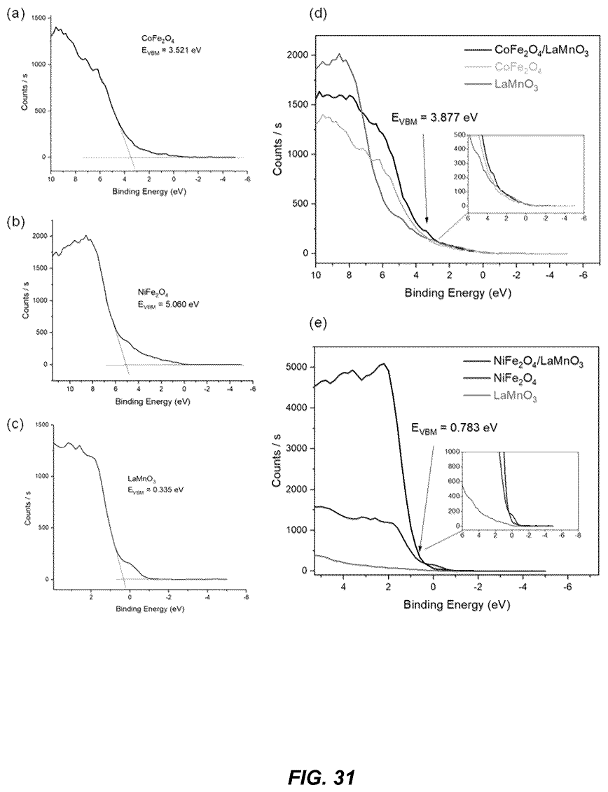

E_{VBM} values reported in Table 10 are identified from the high-resolution XPS valence band spectra, whereas the E_{core} values are preliminarily estimated graphically by using the XPS vacuum survey spectra having a binding energy resolution of 1 eV, and shown in FIG. 30. Surprisingly, The XPS valence band energy regions of the control fibers and their heterocomposites (FIG. 31), demonstrated shifts in the VBM position when two semiconductors (spinel ferrite and lanthanum manganite) were co-present in the fibers. Additionally, the valence band offset (ΔE_{V}) and bandgap energy (E_{g}) values were used to estimate the conduction band offsets (ΔE_{C}) (Table 10) as per Equation (7) below:

$$Δ {E}_{C} = {E}_{g}^{Y} - {E}_{g}^{X} - \vert Δ {E}_{V} \vert \qquad ( 7 )$$

TABLE 10
XPS/UV-vis-NIR DRS data analysis of the valence band and conduction band
energy offsets for both composite fibers.

| CoFe₂O₄/LaMnO₃ | | | NiFe₂O₄/LaMnO₃ | | |
|---|---|---|---|---|---|
| ${E}_{core - Mn 3 p}^{{LaMnO}_{3}}$ | 48.594 | eV | ${E}_{core - Mn 3 p}^{{LaMnO}_{3}}$ | 48.594 | eV |
| ${E}_{VBM}^{{LaMnO}_{3}}$ | 0.335 | eV | ${E}_{VBM}^{{LaMnO}_{3}}$ | 0.335 | eV |
| $( {E}_{core - Mn 3 p}^{{LaMnO}_{3}} - {E}_{VBM}^{{LaMnO}_{3}} )$ | 48.259 | eV | $( {E}_{core - Mn 3 p}^{{LaMnO}_{3}} - {E}_{VBM}^{{LaMnO}_{3}} )$ | 48.259 | eV |
| ${E}_{core - Co 3 p}^{{CoFe}_{2} {O}_{4}}$ | 59.543 | eV | ${E}_{core - Fe 3 p}^{{NiFe}_{2} {O}_{4}}$ | 60.891 | eV |
| ${E}_{VBM}^{{CoFe}_{2} {O}_{4}}$ | 3.521 | eV | ${E}_{VBM}^{{NiFe}_{2} {O}_{4}}$ | 5.060 | eV |
| $( {E}_{core - Co 3 p}^{{CoFe}_{2} {O}_{4}} - {E}_{VBM}^{{CoFe}_{2} {O}_{4}} )$ | 56.022 | eV | $( {E}_{core - Fe 3 p}^{{NiFe}_{2} {O}_{4}} - {E}_{VBM}^{{NiFe}_{2} {O}_{4}} )$ | 55.831 | eV |
| ${E}_{core - Mn 3 p}^{{CoFe}_{2} {O}_{4} / {LaMnO}_{3}}$ | 52.604 | eV | ${E}_{core - Mn 3 p}^{{NiFe}_{2} {O}_{4} / {LaMnO}_{3}}$ | 48.837 | eV |
| ${E}_{core - Co 3 p}^{{CoFe}_{2} {O}_{4} / {LaMnO}_{3}}$ | 59.006 | eV | ${E}_{core - Fe 3 p}^{{NiFe}_{2} {O}_{4} / {LaMnO}_{3}}$ | 55.465 | eV |
| $( {E}_{core - Mn 3 p}^{{CoFe}_{2} {O}_{4} / {LaMnO}_{3}} - {E}_{core - Co 3 p}^{{CoFe}_{2} {O}_{4} / {LaMnO}_{3}} )$ | −6.402 | eV | $( {E}_{core - Mn 3 p}^{{NiFe}_{2} {O}_{4} / {LaMnO}_{3}} - {E}_{core - Fe 3 p}^{{NiFe}_{2} {O}_{4} / {LaMnO}_{3}} )$ | −6.628 | eV |
| E_{g} (LaMnO₃) | 1.90 | eV | E_{g} (LaMnO₃) | 1.90 | eV |
| E_{g} (CoFe₂O₄) | 1.92 | eV | E_{g} (NiFe₂O₄) | 1.93 | eV |
| ΔΕ_{V} | −1.36 | eV | ΔΕ_{V} | −0.94 | eV |
| ΔΕ_{C} | −1.38 | eV | ΔΕ_{C} | −0.97 | eV |

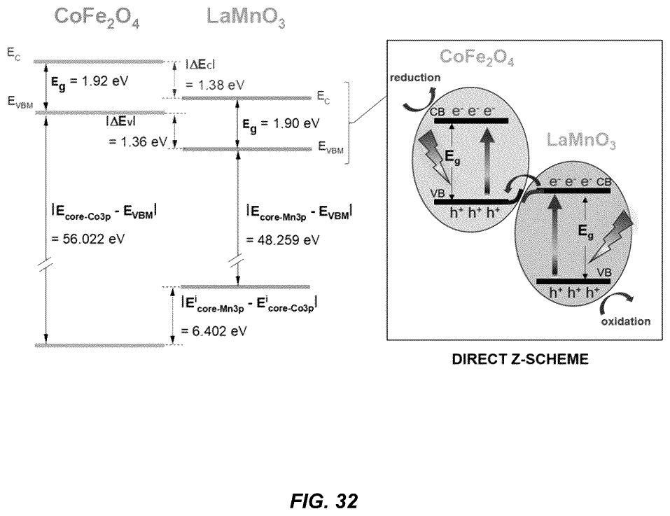

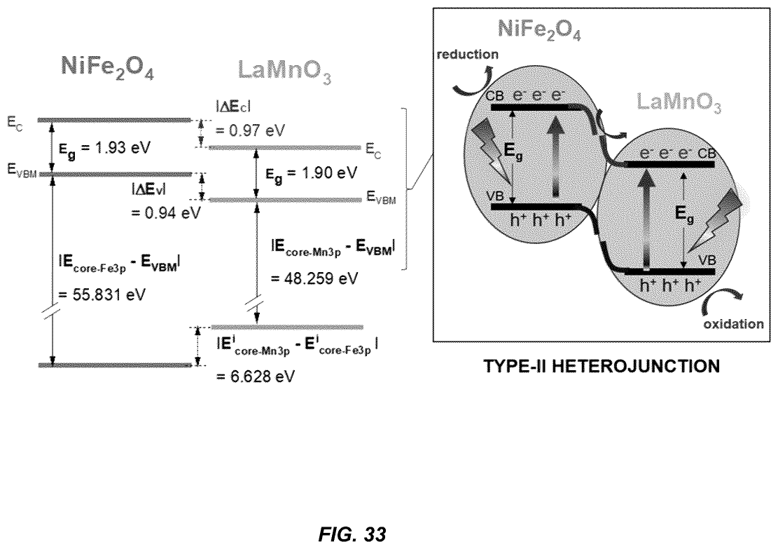

Based on the results above, the energy band diagrams for the CoFe₂O₄/LaMnO₃ and NiFe₂O₄/LaMnO₃ composite fibers are illustrated in FIG. 32 and FIG. 33, respectively. The results show that the CoFe₂O₄/LaMnO₃ heterocomposite fibers form a staggered gap with a direct Z-scheme structure where the spatial separation of charge carriers (e⁻/h⁺ pairs) across the two oxides is beneficial to segregate the oxidation and reduction sites. The Z-scheme heterostructure was suggested from the upward bending of the effective valence band maximum (VBM) position in the composite CoFe₂O₄/LaMnO₃ (E_{VBM}=3.877 eV; FIG. 31(d)) compared to CoFe₂O₄ (E_{VBM}=3.521 eV; FIG. 31(a)). Differently, the NiFe₂O₄/LaMnO₃ heterocomposite fibers form a classic Type-II heterojunction (FIG. 33), where the effective VBM position in the composite NiFe₂O₄/LaMnO₃ (E_{VBM}=0.783 eV; FIG. 31(e)) is downward bent relative to that of NiFe₂O₄ (E_{VBM}=5.060 eV; FIG. 31(b)).

### Example 4: Catalytic Application of the Composite Nanofibers

### Experimental Setup

Photothermal catalysis harnesses light energy, converting it into heat to enhance the efficiency and speed of catalytic reactions. This heat generation is crucial, as it raises the temperature of both the catalyst and the reactants, accelerating the reaction rate, improving selectivity, or enabling the reaction under milder conditions. In some embodiments, the light absorber is a dark material that can absorb radiation from all angles and polarizations, indicating its potential as an efficient catalyst. Thus, in a preferred embodiment, the catalyst produced herein is a dark material. This material can absorb light and convert it into heat through the photo-thermal effect, significantly raising the temperature and thus initiating or accelerating catalytic reactions.

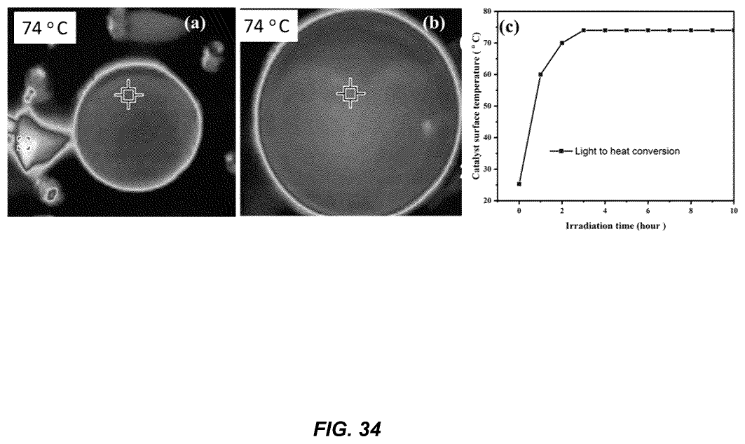

The CoFe₂O₄/LaMnO₃ heterostructure, with a bandgap corresponding to an 855 nm wavelength, effectively responds to Infrared (IR) spectra. Exposure of the heterostructured nanofibers to IR radiation, in the absence of other extrinsic heat sources, led to an increase in the surface temperature of the catalyst to 347 K (74° C.). Infrared thermal camera images were collected of the catalyst surface temperature. Under IR irradiation, the dark-colored CoFe₂O₄/LaMnO₃ absorbs radiation from all directions and polarizations, reducing light reflection. This absorbed radiation is converted into heat, significantly raising the surface temperature of the catalyst from room temperature to 74° C., which triggers and accelerates the catalytic reaction. As shown in FIG. 34 (a-c), after exposure to a 250 W IR lamp, the equilibrium surface temperature of the catalyst stabilizes at 347 K (74° C.).

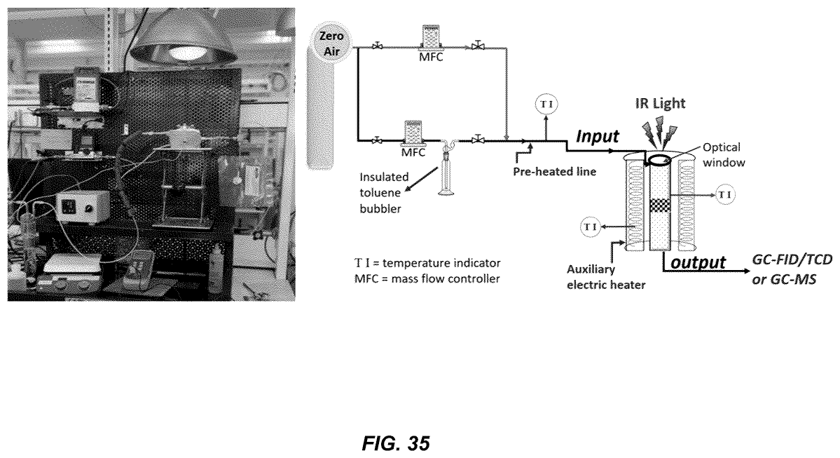

To test the catalytic capabilities of the CoFe₂O₄/LaMnO₃, an experimental setup was configured as outlined in FIG. 35. Specifically, the photothermal catalytic degradation of toluene was carried out in a continuous-flow, closed-gas reaction apparatus equipped with a transparent quartz window. This system comprised four main components: a steady gas flow inlet, a reaction chamber (12 mL), temperature detection via a thermocouple, and exhaust gas. A 40 mg sample of CoFe₂O₄/LaMnO₃ composite was placed at the center of the gas reactor, with a 250 W infrared lamp (light intensity of 280 mW/cm²) serving as the light source, and a working distance (light-to-optical window) of 35 cm. Photothermal catalytic studies were conducted at an equilibrium temperature of 74° C. Toluene gas was generated by bubbling liquid toluene with zero air and subsequently diluting it with additional zero air to achieve an initial concentration of 2,000 parts per million by volume (ppmᵥ). The concentration was controlled by adjusting the flow rate using a mass flow meter, maintaining a total flow rate of 25 mL/min at the reactor inlet, corresponding to a weight hourly space velocity (WHSV) of 37,500 mL·g⁻¹·h⁻¹.

The gas stream from the reactor outlet was sampled every 15 minutes using a Tedlar bag (0.5 L, Restek, USA). The sampling time for gas collection into the Tedlar bag was 2 minutes. A separate Tedlar bag was used for every collection. Before sampling, each Tedlar bag was flushed with air and vacuumed to avoid contamination and memory effect. The collected samples were analyzed by injecting 200 μL of product gas withdrawn from the Tedlar bag using a 1 mL gas-tight syringe (Hamilton, USA) into a Varian 450-GC gas chromatograph equipped with a DB-17 column (30 m length, 0.32 mm inner diameter, and 0.25 μm film thickness; fused silica tubing; cage size: 7 inches). The injector temperature was maintained at 150° C., with injections performed in split mode at a 20:1 split ratio. The oven temperature program began at 80° C., held for 2 minutes, and was ramped at 20° C./min to a final temperature of 230° C., which was sustained for 2 minutes, resulting in a total run time of 11 minutes and 50 seconds. The flame ionization detector (FID) was operated at a set point of 250° C.

For comparison, the thermal catalytic test followed the same approach as the photothermal catalytic test, except that the activity was conducted without light irradiation. The catalyst surface temperature was set to 74° C. using an external heating source. The toluene conversion was estimated using Equation (8).

$$Toluene conversion ( \% ) = \frac{{[ Toluene ]}_{in} - {[ Toluene ]}_{out}}{{[ Toluene ]}_{in}} \times 100 \qquad ( 8 )$$

where, [Toluene]ᵢₙ and [Toluene]ₒᵤₜ represent the concentration of toluene in the gas sampled from the reactor inlet and outlet, respectively.

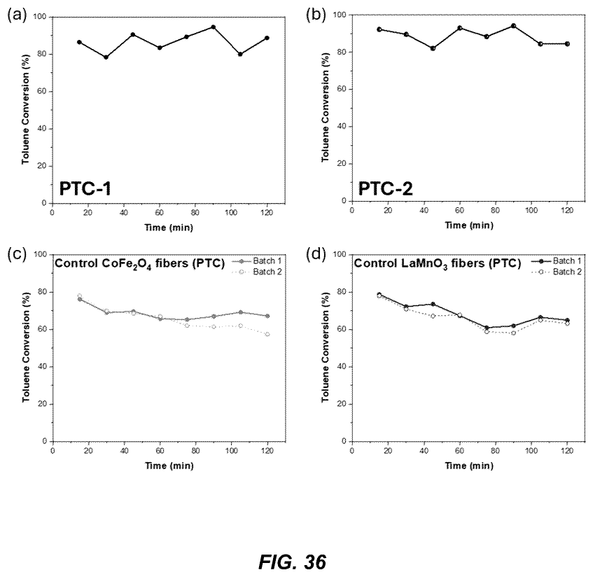

Carbon dioxide (CO₂) production (i.e. toluene mineralization) is qualitatively evidenced by in-situ Diffuse Reflectance Infrared Fourier Transform spectroscopy analysis (in-situ DRIFTS) under similar thermal and irradiation conditions using 40 mg pristine catalysts. Initially, the catalyst was pre-treated with a continuous flow of N₂ (30 mL/min) at room temperature to remove weakly bound adventitious adsorbates. Then, 2,000 ppmᵥ toluene gas in zero air was infused in a continuous flow of (15 mL/min) into the sampling chamber containing the catalyst at room temperature until adsorption equilibrium was achieved. The sampling chamber was purged with N₂ (30 mL/min) to remove excess toluene vapor that could interfere with the measurements by causing light scattering. During thermal and photothermal catalysis, a gas mixture of zero air (21% O₂/N₂) was continuously purged at a 15 mL/min flow rate. The chamber temperature was gradually increased to 74° C. using a built-in electric heating source until thermal equilibrium was reached. DRIFTS spectra were then recorded without irradiation and with light irradiation after 10 minutes and compared to the initial spectra obtained following toluene adsorption at room temperature. FIG. 36 shows the photothermal catalytic conversion results of two separate batches over the composite fibers and their control single oxide fibers. When the photothermal catalytic reaction was driven under light irradiation without extrinsic electric heating, the conversion rate of toluene ranged from 78% to 94% during a continuous two-hour flow, as shown in FIG. 36 (a,b). The results demonstrated that the efficiency of the photothermal catalytic process using the composite materials exceeded that of the control single oxide fibers (FIG. 36(c,d)).

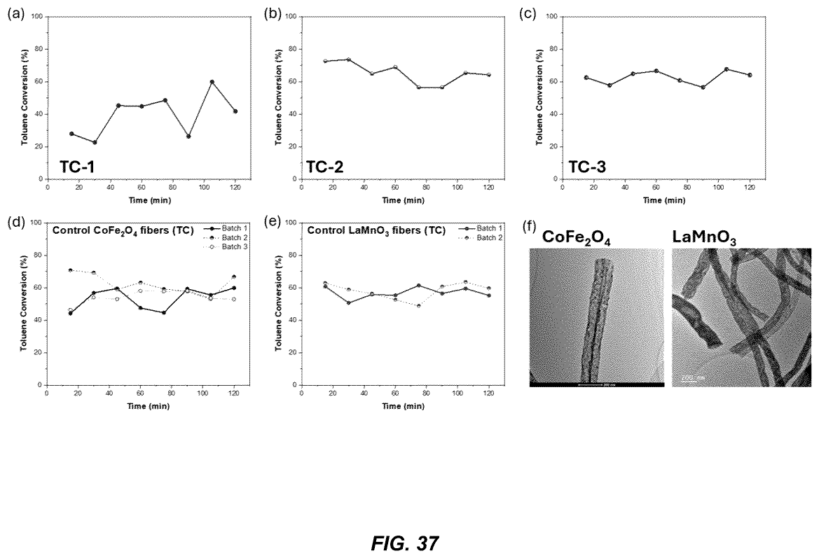

FIG. 37 illustrates the thermal catalytic oxidation results obtained from three pristine batches of composite fibers obtained from the same source of materials prepared for the photothermal catalysis studies shown in FIG. 36. Control thermal catalysis studies were also conducted on several batches of single oxide fibers. The efficiency of toluene conversion by thermal catalysis over the composite fibers (FIG. 37 (a-c)), demonstrated lower toluene conversion (23%-74%) with greater data variation compared to photothermal catalysis, under the same operating temperature. The thermal catalysis efficiency was also within the same range achieved by the control single oxide fibers (FIG. 37(d-e)). Such findings reveal that the combination of light with heat effects provides superior toluene removal efficiency over the heterostructure CoFe₂O₄/LaMnO₃ composite fiber catalyst. Similarly, these results demonstrate that the methods described herein are capable of producing catalysts from spinel ferrites and perovskite oxides. Similarly, FIG. 37 (f) demonstrates control fibers produced from the individual precursor materials.

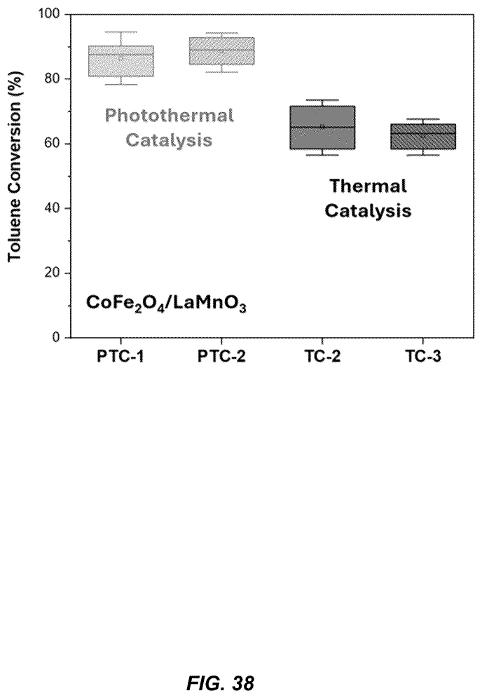

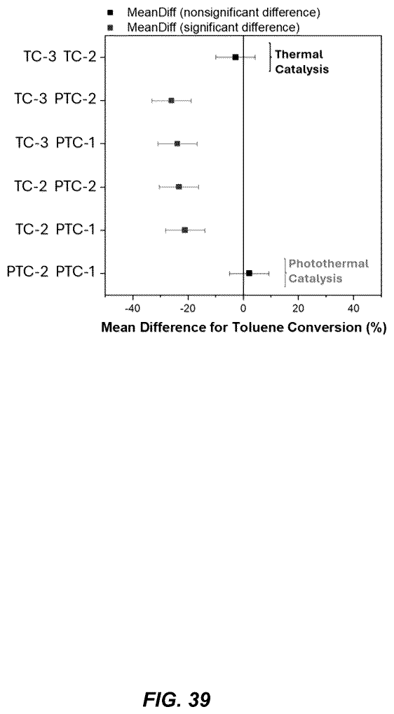

Statistical analysis of the photothermal and thermal catalytic oxidation data using One-way ANOVA with Tukey test (α=0.05). FIG. 38, FIG. 39 and Table 11 all collectively demonstrated that there was no statistically significant difference in toluene conversion between each pair of batches tested by the same catalytic process, confirming batch to batch reproducibility of the catalytic performance. Similarly, the results demonstrated a statistically significant difference between the results of the two catalytic processes (e.g., photothermal catalysis vs thermal catalysis) based on the toluene conversion performance indicator. In FIG. 38, the box plots show the mean value of the performance indicator, median value, and lower/upper quartiles for each tested batch; The whiskers indicate the minimum and maximum estimated values from the sampling points (N=8 per batch, per process). FIG. 39 illustrates the mean comparison plot based on the Tukey test for toluene conversion attained with different batches of CoFe₂O₄/LaMnO₃ fibers under photothermal catalysis (PTC-1/PTC-2) and thermal catalysis (TC-2/TC-3). The statistical test results are summarized in Table 11.

TABLE 11
Tukey test for the comparison of means of toluene conversion
achieved by CoFe₂O₄/LaMnO₃ fibers under photothermal catalysis
(PTC-1/PTC-2) and thermal catalysis (TC-2/TC-3).

| | | Standard | | | | | | |
|---|---|---|---|---|---|---|---|---|
| | Mean | Error of | | | | | | |
| | Diff | Mean | q Value | Prob | Alpha | Sig | LCL | UCL |
| PTC-2/PTC-1 | 2.186 | 2.604 | 1.18728 | 0.835 | 0.05 | 0 | −4.924 | 9.297 |
| TC-2/PTC-1 | −21.083 | 2.604 | 11.44871 | 2.72E−8 | 0.05 | 1 | −28.194 | −13.973 |
| TC-2/PTC-2 | −23.270 | 2.604 | 12.63599 | 0 | 0.05 | 1 | −30.380 | −16.159 |
| TC-3/PTC-1 | −23.827 | 2.604 | 12.93861 | 4.742E−8 | 0.05 | 1 | −30.937 | −16.716 |
| TC-3/PTC-2 | −26.013 | 2.604 | 14.12590 | 2.225E−7 | 0.05 | 1 | −33.124 | −18.903 |
| TC-3/TC-2 | −2.744 | 2.604 | 1.48990 | 0.720 | 0.05 | 0 | −9.854 | 4.367 |

Prob: probability; Sig: significant (for sig = 1, the result is statistically significant); LCL: lower control limit; UCL: upper control limit.

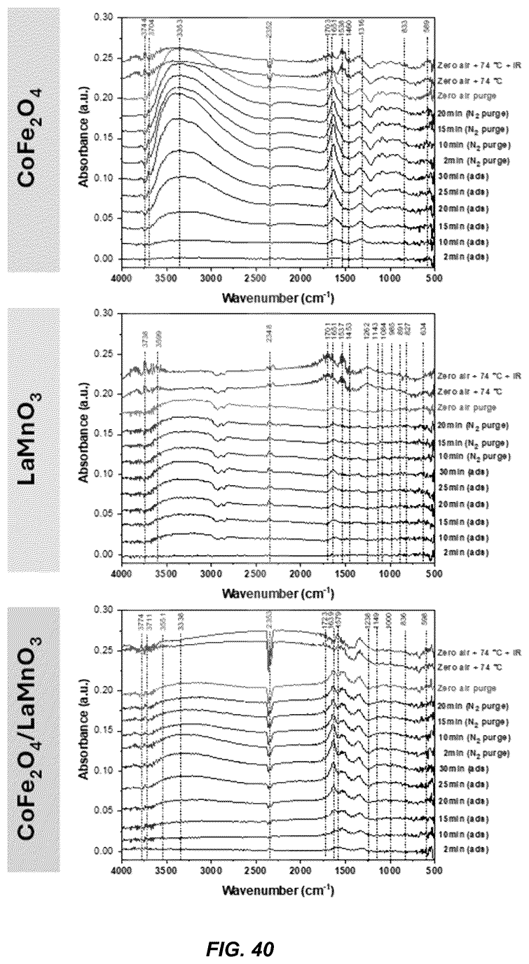

The combination of CoFe₂O₄ and LaMnO₃ forms a unique Z-scheme heterostructure that enhances light utilization. The evidenced photothermal behavior of the composite semiconductor in FIG. 34(c) suggests an increased probability of non-radiative recombination of photogenerated electrons and holes during IR irradiation, which could be associated with an increase in the concentration of free energy carriers. During the photothermal process, photoabsorption may influence the dynamics of formation of surface oxygen vacancy formation, and thus the number of reactive sites at the catalyst-gas interface. Typically, in the CoFe₂O₄/LaMnO₃ e-h pair recombination may be favored at the cobalt ferrite-lanthanum manganate interface as reported in the analysis of the charge transfer in the Z-scheme heterostructure depicted in FIG. 32. The heat generated by the photothermal process may therefore be responsible for activating the thermal catalysis pathway. Meanwhile, the spatially segregated electrons and holes at each semiconductor catalyst particle can influence the dynamics of oxygen vacancy formation and oxygen adsorption, therefore enhancing and sustaining the toluene conversion and mineralization to achieve a greater efficiency beyond that of a purely thermally driven catalytic process. In addition, spatially segregated holes at the LaMnO₃ catalyst particle, as depicted in FIG. 32, may introduce oxidation centers for toluene radical formation, therefore activating the photocatalytic pathway. Accordingly, the photothermal catalytic degradation of toluene over the composite may likely involve cooperative photo-driven thermal catalysis (heat generation through photothermal effect), photo-assisted thermal catalysis (dynamic formation of active sites), and thermally assisted photocatalysis (thermally enhanced charge transfer kinetics and charge segregation through the Z-scheme heterostructure). The thermal and photothermal conversion of toluene over the composite CoFe₂O₄/LaMnO₃ fiber catalyst and its control single oxide fibers were evaluated by in-situ DRIFTS analysis (FIG. 40, Table 12).

TABLE 12
In-situ DRIFTS results.

| | IR band | |
|---|---|---|
| | Wavenumber | |
| Catalyst | (cm⁻¹) | IR vibrational mode |
| CoFe₂O₄ fibers | 3744 | CO₂ combination bands |
| (control) | 3704 | Free O—H stretching during adsorption and |
| | | gas purge |
| | 3353 | Hydrogen-bonded O—H stretching |
| | 2352 | O═C═O asymmetric stretching in CO₂ |
| | 1703 | C═O carbonyl stretching (conjugated, |
| | | benzaldehyde) |
| | 1651 | C═O stretching (hydroxybenzaldehyde) and |
| | | H—O—H bending |
| | 1538 | C═C stretching in aromatic ring |
| | 1460 | C—O—H bending (obscuring |
| | | H—C—H bend from toluene) |
| | 1316 | C—O stretching |
| | 833 | Aromatic C—H bending with para substitution |
| | 589 | Aromatic C—H bending found in |
| | | hydroxybenzaldehyde |
| LaMnO₃ fibers | 3738, 3599 | CO₂ combination bands |
| (control) | 2348 | O═C═O asymmetric stretching |
| | 1701 | C═O (conjugated) |
| | 1651 | C═O stretching (benzaldehyde) and C═C |
| | | stretching aromatic ring (toluene) and H—O—H |
| | | bending |
| | 1537 | C═C stretching aromatic ring |
| | 1453 | C—O—H bending (obscuring H—C—H bend from |
| | | toluene) |
| | 1262 | C—O stretching |
| | 1143 | C—C—H bending around carbonyl group |
| | | (aldehyde) |
| | 1084 | C—C stretching (alkyl moiety - toluene) |
| | 985 | C—OH stretching |
| | 891 | C—O—H bending |
| CoFe₂O₄/LaMnO₃ | 3774, 3711 | CO₂ combination bands |
| fibers | 3551, 3338 | Hydrogen bonded O—H stretching |
| | 2353 | O═C═O asymmetric stretch |
| | 1723 | C═O symmetric stretching |
| | 1639 | C═O stretching (benzaldehyde) and C═C |
| | | stretching aromatic ring (toluene) and H—O—H |
| | | bending |
| | 1579 | C═C stretching aromatic ring |
| | 1238 | C—O stretching |
| | 1149 | C—C—H bending around carbonyl group |
| | | (aldehyde) |
| | 1000 | C—O stretching |
| | 836 | Aromatic C—H bending with para substitution |
| | 598 | Aromatic C—H bending found in |
| | | hydroxybenzaldehyde |

According to FIG. 40 and Table 12 results, the intensity of the asymmetric IR stretching band for adsorbed Co₂ at 2353 cm⁻¹, which is indicative of toluene mineralization, increases upon exposing the surface of the catalysts to heat and light irradiation. This band is more pronounced in the DRIFT pattern of the fiber composite compared to that of the control single oxides. Spectral changes in the region of 800-1730 cm⁻¹ under thermal and photothermal catalysis conditions may be attributed to the decomposition of toluene and the formation of adsorbed intermediates. The results described above demonstrate the increased efficiency of the multi-metallic oxide catalysts as compared to the single oxide catalyst. Similarly, the multi-metal oxide catalysts demonstrated improved photothermal and thermal catalysis as compared to the control groups.

### Stability Testing of the Nanofiber Composites

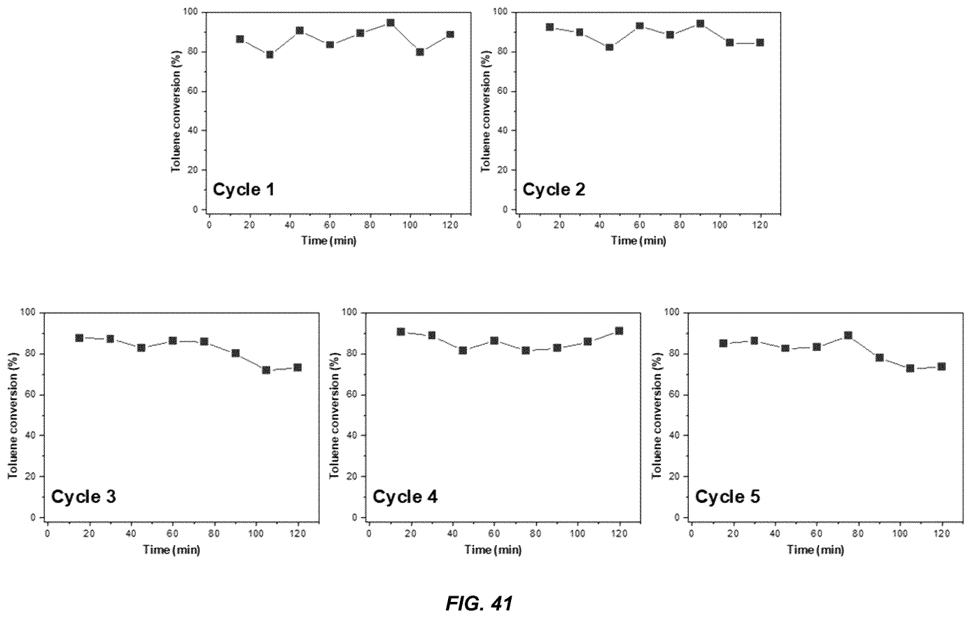

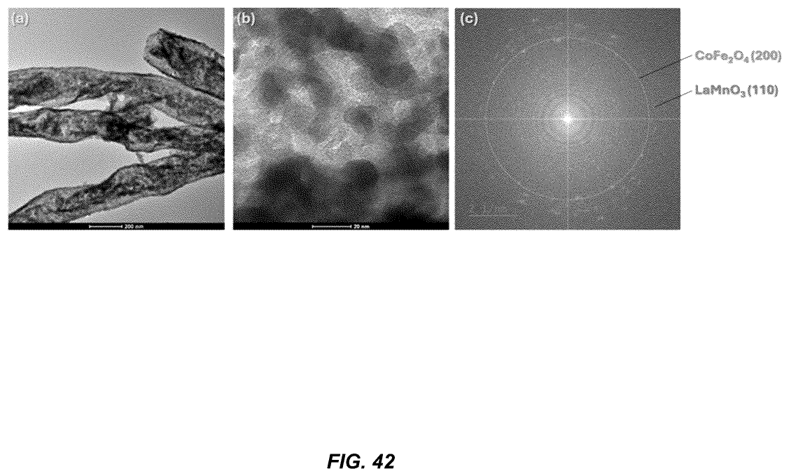

The CoFe₂O₄/LaMnO₃ catalyst demonstrated notable stability, maintaining nearly the same efficiency in toluene conversion even after five consecutive cycles of continuous flow experiments. The results may be seen in FIG. 41. For example, across all 5 cycles, the toluene conversion was at or greater than 75%, demonstrating an efficient conversion of toluene using the nanofibers. Evaluating the morphology of the spent fibers, it was observed that the fibers retained their crystallinity after a total of 10 hours of cycling (e.g., five consecutive 120 minute catalytic cycles) (FIG. 42).

Similarly, a total time on stream was evaluated for the CoFe₂O₄/LaMnO₃ fiber catalysts in continuous-flow operation under the experimental conditions reported in FIG. 42. For example, the experimental conditions included a 40 mg catalytic load, a toluene vapor concentration of 2000 ppmᵥ, WHSV of 37,000 mL·g⁻¹·h⁻¹, the irradiation source was a 250 W IR lamp (280 mW/cm²), and T_{equilibrium} was 74° C. (no external heating supply). The linear curve fit is for visual aid.

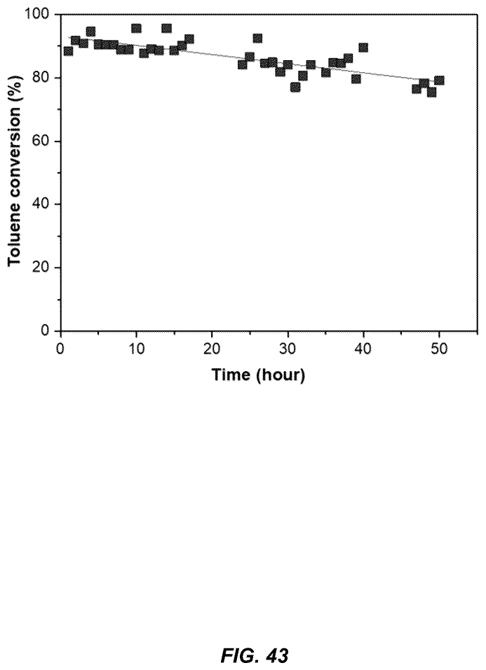

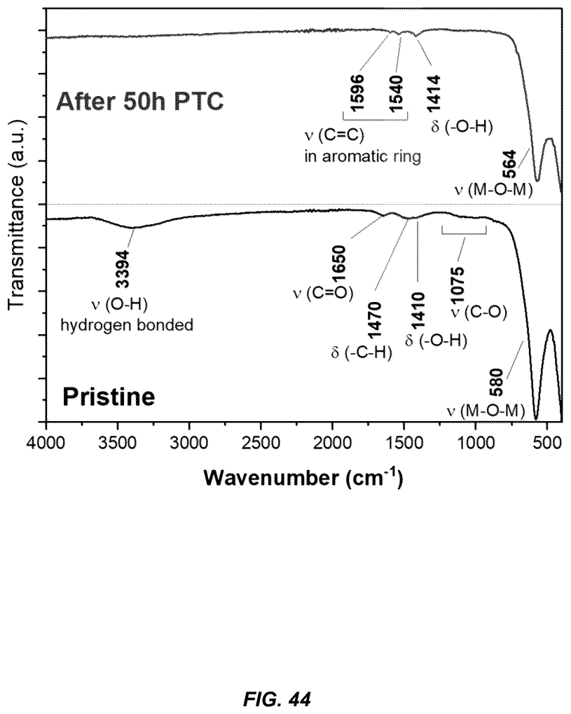

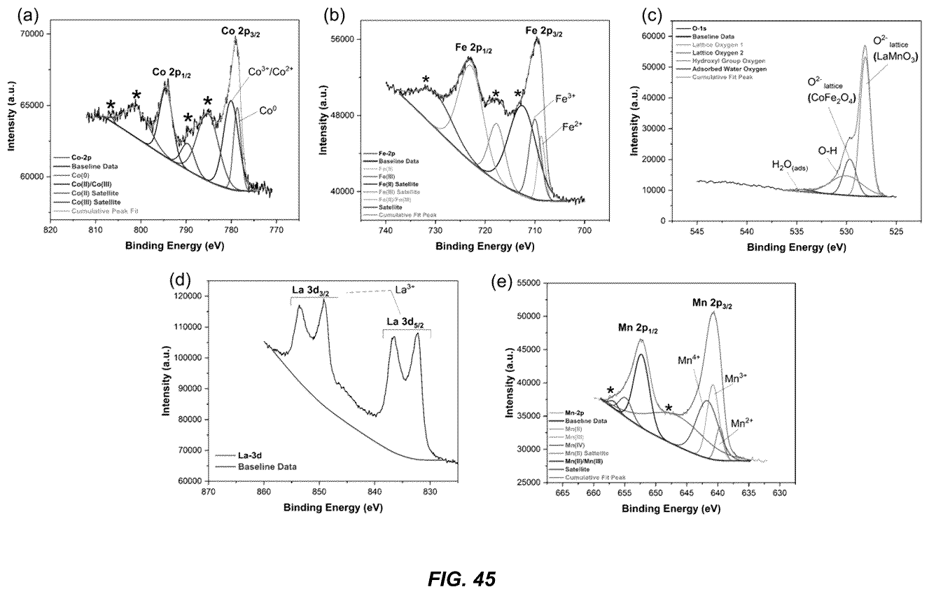

Turning to the attenuated total reflectance-FTIR of the pristine catalyst demonstrated the presence of residual organic moieties such as C—H that could be left over from the short calcination program (2 hours as described in section 5.3) or due to adventitious carbon, and the presence of O—H and C═O/C—O moieties that could be attributed to adsorbed water and carbonate species (FIG. 44). The spectrum of the spent catalyst following 50 hour photothermal catalysis shows the loss of the characteristic vibrations of O—H groups (i.e. loss of adsorbed water) and the presence of fingerprint-specific IR vibrations that can be related to the presence of adsorbed toluene and toluene intermediates on the catalyst surface. The XPS analysis of the surface chemical states of the spent catalyst reported in FIG. 43 are shown in FIG. 45. The data demonstrates changes in the distribution of the metal oxidation states, and those of oxygenates compared to those of the pristine material (see FIG. 25) corroborating the role of surface species in regulating the adsorption of species and catalytic reactions.

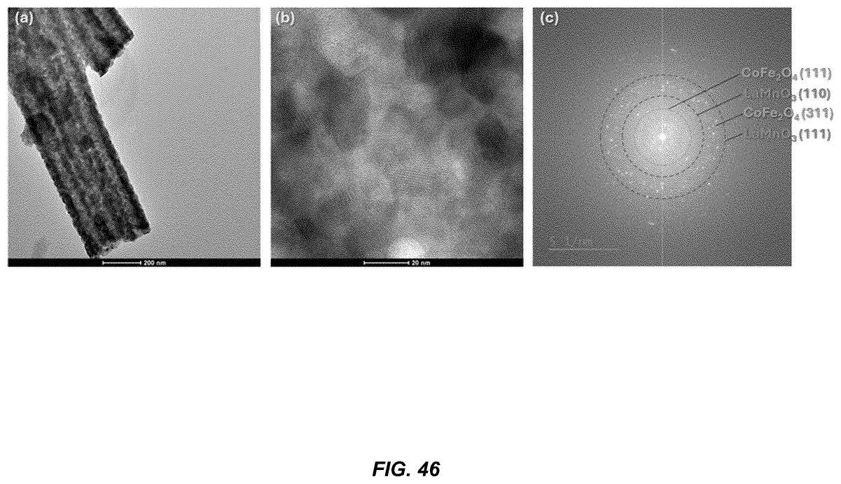

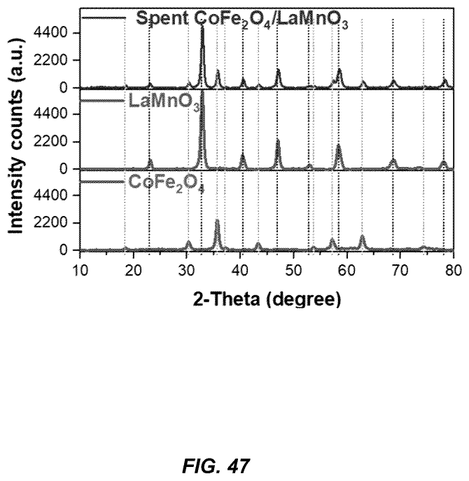

The TEM data and p-XRD results shown in FIG. 46 and FIG. 47, confirmed the retention of the crystalline microstructure of the catalyst after being subjected to a 50-hour time on-stream photothermal catalysis test. Therefore, the formation of surface-adsorbed intermediates and changes in surface oxidation states of the catalyst were not accompanied by measurable microstructural and crystallinity changes, suggesting adequate thermal and chemical stability of the material under the reaction temperature, and applied light irradiation and gaseous stream conditions.

Table 13 summarizes the performance of various photothermal catalysts for the degradation of toluene in continuous-flow systems. The exceptional photothermal catalytic performance of the one-pot synthesized CoFe₂O₄/LaMnO₃ fiber catalyst (the method described herein) for toluene degradation and mineralization is achieved with reduced operating requirements such as (i) low mass of catalyst, (ii) fast degradation, (iii) conversion efficiency achievement at lowest reported equilibrium temperature, and (iii) lower irradiation intensity and spectral energy requirements. As similarly described above, the catalytic testing was explored under different flow rate conditions to match various custom-made photoreactors. Adjustments in the flow rate and mass loading of the catalyst may depend on the size of the reactor used. Therefore, in real applications (e.g. portable indoor ventilation devices, integration with HVAC ventilation, or online with industrial post-combustion treatment of flue gases, one skilled in the art would understand that changing parameters, such as the volumetric flow and scale of technology involved, may be adjusted to achieve the above catalysts.

TABLE 13
Comparison of the performance of various catalysts in the photothermal catalytic
degradation of toluene under continuous systems, at relative humidity (RH) of 0%.

| | | | Morphology | | | Toluene |
|---|---|---|---|---|---|---|
| | | | of tested | Catalyst | | conc. (ppmᵥ)/ |
| Sample ID | Catalyst | Synthesis method | catalyst | mass | | carrier gas |
| A | CoFe₂O₄/LaMnO₃ | One pot | Fibers | 40 | mg | 2000/zero |
| | | electrospinning + | | | | air |
| | | calcination | | | | |
| B | CoFe₂O₄ | Electrospinning + | Fibers | 40 | mg | 2000/zero |
| | (control) | calcination | | | | air |
| C | LaMnO₃ | Electrospinning + | Fibers | 40 | mg | 2000/zero |
| | (control) | calcination | | | | air |
| D | CuMn₂O₄/ | Sol-gel | Powder | NR* | | 1000/air |
| | Biochar/ | impregnation + | | | | |
| | Honeycomb | calcination | | | | |
| E | LaSmNiMnO₆ | Sol-gel + | Powder | NR* | | 1000/mix of |
| | | calcination | | | | 20% O₂/N₂ |
| F | LaCoO₃/ | Sol-gel + | Powder | 1000 | mg | 500/air |
| | biochar | calcination | | | | |
| G | Mn₃O₄/Co₃O₄ | Hydrothermal | Powder | 100 | mg | 500/mix. of |
| | | coprecipitation + | | | | 20% O₂/N₂ |
| | | calcination | | | | |
| H | La_{0.9}Fe_{0.1}MnO₃ | Sol-gel + | Powder | 100 | mg | 500/mix. of |
| | | calcination | | | | 20% O₂/N₂ |
| I | CoAlOx | Hydrothermal | Powder | 100 | mg | 500/air |
| | (CoAl- | treatment + intense | | | | |
| | LDH-L2) | photo-oxidation | | | | |
| J | α- | Co-precipitation + | Powder | 40 | mg | 300/air |
| | MnO₂/Mn₃O₄ | calcination | | | | |
| K | NiCo₂O₄ | Co-precipitation | Needle- | 25 | mg | 220/air |
| | | | shaped | | | |
| | | | microparticles | | | |
| L | ZnMn₂O₄ | Hydrothermal | Powder | 100 | mg | 200/air |
| | | treatment + | | | | |
| | | calcination | | | | |
| M | Cu-doped | Hydrothermal | Powder | 100 | mg | 200/air |
| | ZnMn₂O₄ | treatment + | | | | |
| | (ZMO-4Cu) | calcination | | | | |
| N | Acid-etched | Acrylamide | Powder | 100 | mg | 200/air |
| | LaTi_{0.6}Mn_{0.4}O_{3+δ} | polymerization | coated on | | | |
| | | route + calcination | fiber-glass | | | |
| | | | membrane | | | |
| O | CeO₂/LaMnO₃ | Citric acid | Powder | 100 | mg | 200/mix. of |
| | | combustion method + | coated on | | | 21% O₂/N₂ |
| | | calcination | fiber-glass | | | |
| | | | membrane | | | |
| P | LaMn_{1.3}O₃ | Citric acid | Powder | 30 | mg | 200/mix. of |
| | | combustion method + | | | | 21% O₂/N₂ |
| | | calcination | | | | |
| Q | Co₃O₄/TiO₂ | Hydrothermal | Powder | 100 | mg | 200/mix. of |
| | | treatment + | | | | O₂/Ar |
| | | calcination | | | | |
| R | CuOₓ—CeO₂₋ₓ- | Two-step synthesis + | Powder | 30 | mg | 200/mix. of |
| | STO/USY | multiple heat- | coated on | | | 20% O₂/N₂ |
| | | treatments | fiber-glass | | | |
| | | | membrane | | | |
| S | Pt/MOOₓ | Two-step synthesis + | Powder | ca. 100 | mg | 200/air |
| | | heat treatments | coated on | | | |
| | | | fiber-glass | | | |
| | | | membrane | | | |

| | | Light | T_{eq} | | Space | | |
|---|---|---|---|---|---|---|---|
| | | intensity | (reaction | | velocity (mL | Toluene | |
| Sample ID | Light source | (mW cm⁻²) | temperature) | | g⁻¹ h⁻¹) | conversion | Ref. |
| A | 250 W, IR | 280 | 74° | C. | 37,500 | 78-94% | This |
| | lamp (≥600 nm) | | | | | | work |
| B | 250 W, IR | 280 | 74° C. | | 37,500 | 62-77% | This |
| | lamp (≥600 nm) | | (electric | | | | work |
| | | | heating | | | | |
| | | | assisted) | | | | |
| C | 250 W, IR | 280 | 74° C. | | 37,500 | 60-78% | This |
| | lamp (≥600 nm) | | (electric | | | | work |
| | | | heating | | | | |
| | | | assisted) | | | | |
| D | 300 W, Xe | NR* | 263° C. | | 10,000 | 90% | [37] |
| | lamp | | (electric | | | | |
| | (320-2500 nm) | | heating | | | | |
| | | | assisted) | | | | |
| E | 500 W, Xe | NR* | 255° C. | | 18,000 h⁻¹ | 90% | [38] |
| | lamp | | (external | | GHSV) | | |
| | (420-2500 nm) | | heating | | | | |
| | | | assisted) | | | | |
| F | 300 W, Xe | 350 | 270° C. | | 10,000 | 90% | [39] |
| | lamp | | (electric | | | | |
| | (simulated | | heating | | | | |
| | solar | | assisted) | | | | |
| | spectrum) | | | | | | |
| G | 300 W, Xe | 822 | 160° | C. | 30,000 | 74.7% | [40] |
| | (320-780 nm) | | | | | | |
| H | 300 W, Xe | 1300 | 183° | C. | 30,000 | 86.7% | [11] |
| | lamp | | | | | | |
| | (320-2500 nm) | | | | | | |
| I | 300 W, Xe | 1400 | 90° | C. | 12,000 | 99% | [41] |
| | lamp | | | | | | |
| | (320-2500 nm) | | | | | | |
| J | 300 W, Xe | 764 | 135° | C. | 90,000 | 95% | [42] |
| | lamp | | | | | | |
| | (400-2500 nm) | | | | | | |
| K | 375 W, IR | 400 | 235° | C. | 32,000 | 93% | [43] |
| | lamp | | | | | | |
| | (≥600 nm) | | | | | | |
| L | Xe lamp | 500 | 158° | C. | 36,000 | 92% | [44] |
| | (300-2500 nm) | | | | | | |
| M | Xe lamp | 420 | 160° | C. | 36,000 | 95% | [45] |
| | (300-2500 nm) | | | | | | |
| N | 300 W, Xe | 650 | 227.5° | C. | 30,000 | 95.6% | [46] |
| | lamp | | | | | | |
| | (300-2500 nm) | | | | | | |
| O | 375 W, IR | 280 | 275° | C. | 31,320 | 89% | [47] |
| | lamp with | | | | | | |
| | cutoff filter | | | | | | |
| | (≥800 nm) | | | | | | |
| P | simulated | >1130 | 172 ± 3° | C. | 26,000 | 98% | [48] |
| | solar | | | | | | |
| | light <1 SUN | | | | | | |
| | coupled | | | | | | |
| | with | | | | | | |
| | convergence | | | | | | |
| | lens | | | | | | |
| Q | 300 W, Xe | 908.7 | 200° | C. | 30,000 | 90% | [49] |
| | lamp | | | | | | |
| | (300-2500 nm) | | | | | | |
| R | 200-2500 nm | 700 | 227° | C. | ca. 30,000 | 86.2% | [35] |
| S | Full solar | 200 | 142° | C. | 30,000 | 90% | [36] |
| | irradiation | | | | | | |

*NR: not reported
ca.: calculated

### REFERENCES

[1] Hong J, Xu C, Deng B, Gao Y, Zhu X, Zhang X, et al. Photothermal Chemistry Based on Solar Energy: From Synergistic Effects to Practical Applications. Advanced Science 2022; 9(3):2103926.
[2] Salih S J, Mahmood W M. Review on magnetic spinel ferrite (MFe₂O₄) nanoparticles: From synthesis to application. Heliyon 2023; 9(6):e16601.
[3] Zhou X, Zhao Y, Cao X, Xue Y, Xu D, Jiang L, et al. Fabrication of polycrystalline lanthanum manganite (LaMnO3) nanofibers by electrospinning. Materials Letters 2008; 62(3):470-2.
[4] Ju Y-W, Park J-H, Jung H-R, Cho S-J, Lee W-J. Fabrication and characterization of cobalt ferrite (CoFe₂O₄) nanofibers by electrospinning. Materials Science and Engineering: B 2008; 147(1):7-12.
[5] Chen D, Yi J. One-pot electrospinning and gas-sensing properties of LaMnO₃ perovskite/SnO2 heterojunction nanofibers. Journal of Nanoparticle Research 2018; 20(3):65.
[6] Yue B, Hu Q, Yu W, Ma Q, Bao Y, Li L, et al. Perovskite-type RMnO3 (R=La, Nd, Eu) nanofibers with fast Li+ transport properties as anode for lithium-ion batteries. Materials Today Communications 2023; 36:106459.
[7] Hu Q, Yue B, Shao H, Yang F, Wang J, Wang Y, et al. Facile syntheses of perovskite type LaMO3 (M=Fe, Co, Ni) nanofibers for high performance supercapacitor electrodes and lithium-ion battery anodes. Journal of Alloys and Compounds 2021; 852:157002.
[8] Nie G, Zhang Z, Wang T, Wang C, Kou Z. Electrospun One-Dimensional Electrocatalysts for Oxygen Reduction Reaction: Insights into Structure-Activity Relationship. ACS Applied Materials & Interfaces 2021; 13(32):37961-78.
[9] Vikhnin V S, Kapphan S, Melekh B A, Shadrin E B. Jahn-Teller polarons and peculiarities of their absorption in LaMnO₃ and La1−xSrxMnO3 perovskite-like systems. Ferroelectrics 1999; 235(1):211-20.
[10] Wahba M A, Sharmoukh W, Yakout S M, Khalil M S. Fast and full spectrum sunlight photocatalysts: Fe/Co or Ni implanted multiferroic LaMnO₃. Optical Materials 2022; 124:111973.
[11] Yu Q, Li C, Zhao J, Liu X, Huang L, Zhu Y, et al. Efficient photothermal catalytic oxidation of toluene by La1−xFexMnO3 with full spectrum response: The effects of Fe doping and photoactivation. Applied Catalysis B: Environmental 2023; 327:122441.
[12] Bilgin Simsek E, Tuna Ö. Boosting redox cycle and increased active oxygen species via decoration of LaMnO₃ spheres with CeO2 flowers to promote Fenton-like catalytic degradation of various organic contaminants. Optical Materials 2023; 137:113564.
[13] Hafeez H Y, Lakhera S K, Narayanan N, Harish S, Hayakawa Y, Lee B-K, et al. Environmentally Sustainable Synthesis of a CoFe2O4-TiO2/rGO Ternary Photocatalyst: A Highly Efficient and Stable Photocatalyst for High Production of Hydrogen (Solar Fuel). ACS Omega 2019; 4(1):880-91.
[14] Low J, Yu J, Jaroniec M, Wageh S, Al-Ghamdi A A. Heterojunction Photocatalysts. Advanced Materials 2017; 29(20):1601694.
[15] López-Ortega A, Lottini E, Fernández Cd J, Sangregorio C. Exploring the Magnetic Properties of Cobalt-Ferrite Nanoparticles for the Development of a Rare-Earth-Free Permanent Magnet. Chemistry of Materials 2015; 27(11):4048-56.
[16] Zhang W A, Esposito V, Ramousse S, Jensen J O. Method for producing and controlling the morphology of metal-oxide nanofiber and/or nanotube catalysts. WO Patent 2,015,169,786; 2015.
[symbol] . Nickel-copper-zinc ferrite magnetic nano shuttle and preparation method thereof. Chinese Patent CN114566372A; 2022.
[symbol] . Self-supporting perovskite type oxide nano ber catalytic puri cation material and preparation method thereof. Chinese Patent CN109331807B; 2018.
[19] Darwish M S A, Kim H, Lee H, Ryu C, Lee J Y, Yoon J. Synthesis of Magnetic Ferrite Nanoparticles with High Hyperthermia Performance via a Controlled Co-Precipitation Method. Nanomaterials 2019; 9(8):1176.
[20] Singh N, Malik A, Nohwar S, Jana R, Mondal P C. Covalent surface modification of nickel ferrite nanoparticles for electrochemical supercapacitor performance. New Journal of Chemistry 2023; 47(11):5308-15.
[21] Tang Y, Shih K, Liu C, Liao C. Cubic and tetragonal ferrite crystal structures for copper ion immobilization in an iron-rich ceramic matrix. RSC Advances 2016; 6(34):28579-85.
[22] Gholizadeh A. X-ray peak broadening analysis in LaMnO3+ δ nano-particles with rhombohedral crystal structure. Journal of Advanced Materials and Processing 2015; 3(3):71-83.
[23] Lowell S, Shields J E, Thomas M A, Thommes M. Characterization of porous solids and powders: surface area, pore size and density. Springer Science & Business Media; 2012.
[24] Peterson G W, Epps III T H. Impact of zinc salt counterion on poly (ethylene oxide) solution viscosity, conductivity, and ability to generate electrospun MOF/nanofiber composites. Polymer 2022; 252:124816.
[25] Peddis D, Yaacoub N, Ferretti M, Martinelli A, Piccaluga G, Musinu A, et al. Cationic distribution and spin canting in CoFe₂O₄ nanoparticles. Journal of Physics: Condensed Matter 2011; 23(42):426004.
[26] Celorrio V, Dann E, Calvillo L, Morgan D J, Hall S R, Fermin D J. Oxygen Reduction at Carbon-Supported Lanthanides: The Role of the B-Site. ChemElectroChem 2016; 3(2):283-91.
[27] Jiang Y, Li Z, Zhu T, Li D, Wang H, Zhu X. Oxygen Storage Characteristics and Redox Behaviors of Lanthanum Perovskite Oxides with Transition Metals in the B-Sites. Energy & Fuels 2023; 37(13):9419-33.
[28] Li P, Xuan Y, Jiang B, Zhang S, Xia C. Hollow La0.6Sr0.4Ni0.2Fe0.75Mo0.05O3−δ electrodes with exsolved FeNi3 in quasi-symmetrical solid oxide electrolysis cells for direct C02 electrolysis. Electrochemistry Communications 2022; 134:107188.
[29] Yurdakal S, Garlisi C, Ozcan L, Bellardita M, Palmisano G. (Photo) catalyst characterization techniques: adsorption isotherms and BET, SEM, FTIR, UV-Vis, photoluminescence, and electrochemical characterizations. Heterogeneous photocatalysis. Elsevier; 2019, p. 87-152.
[30] Kraut E, Grant R, Waldrop J, Kowalczyk S. Precise determination of the valence-band edge in x-ray photoemission spectra: application to measurement of semiconductor interface potentials. Physical Review Letters 1980; 44(24):1620.
[31] Fares C, Tadjer M J, Woodward J, Nepal N, Mastro M A, Eddy C R, et al. Valence and conduction band offsets for InN and III-nitride ternary alloys on (−201) bulk β-Ga2O3. ECS Journal of Solid State Science and Technology 2019; 8(7):Q3154.
[32] Huang J, Liu C, Zhu Y, Masala S, Alarousu E, Han Y, et al. Harnessing structural darkness in the visible and infrared wavelengths for a new source of light. Nature nanotechnology 2016; 11(1):60-6.
[33] Cui X, Ruan Q, Zhuo X, Xia X, Hu J, Fu R, et al. Photothermal nanomaterials: a powerful light-to-heat converter. Chemical Reviews 2023; 123(11):6891-952.
[34] Bi Y, Ji G, Wang Y, Sun E, Feng C, Han F, et al. In-situ modulation of α-MnO₂ surface oxygen vacancies for photothermal catalytic oxidation of propane: Insights into activity and synergistic mechanism. Chemical Engineering Journal 2023; 473:145474.
[35] Elimian E A, Zhang M, Li Q, Sun Y, He J, Jia H. Tailoring CuO—CeO2 active sites on strontium titanate/ultra-stable Y zeolite catalyst for photothermal catalytic oxidation of toluene. Separation and Purification Technology 2024; 340:126771.
[36] Yu E, Li J, Chen J, Chen J, Hong Z, Jia H. Enhanced photothermal catalytic degradation of toluene by loading Pt nanoparticles on manganese oxide: Photoactivation of lattice oxygen. Journal of hazardous materials 2020; 388:121800.
[37] Lu X, Zhang C, Wu M, Liu W, Xue B, Yao C, et al. Construction of spinel/biochar film/honeycomb monolithic catalyst for photothermal catalytic oxidation of VOCs. Frontiers of Chemical Science and Engineering 2024; 18(9):1-11.
[38] Tang Y, Tao Y, Wang Q, Zhu Z, Zhang W, Li X, et al. Mesoporous double-perovskite LaAMnNiO6 (A=La, Pr, Sm) photothermal synergistic degradation of gaseous toluene. Journal of Materials Research 2019; 34(20):3439-49.[39]
[39] Huang J, Zhang Y, Wu M, Zuo S, Yao C, Ni C, et al. Photothermal catalytic oxidation of toluene by perovskite oxide/biochar nanocomposite: Effect of biomass incorporation. Separation and Purification Technology 2024; 330:125316.
[40] Zhao J, Li C, Yu Q, Zhu Y, Liu X, Li S, et al. Interface engineering of Mn3O4/Co3O4 S-scheme heterojunctions to enhance the photothermal catalytic degradation of toluene. Journal of Hazardous Materials 2023; 452:131249.
[41] Bi R, Chen Y, Tang M, Zhu J, Zhu Y, Lan T, et al. Light-induced phase transformation to two-dimensional amorphous spinel CoAlOx nanosheets as a tandem photothermal catalyst for efficient and durable toluene oxidation. Separation and Purification Technology 2024; 346:127427.
[42] Wu P, Dai S, Chen G, Zhao S, Xu Z, Fu M, et al. Interfacial effects in hierarchically porous α-MnO₂/Mn3O4 heterostructures promote photocatalytic oxidation activity. Applied Catalysis B: Environmental 2020; 268:118418.
[43] Chen X, Cai S, Yu E, Li J, Chen J, Jia H. Photothermocatalytic performance of ACo2O4 type spinel with light-enhanced mobilizable active oxygen species for toluene oxidation. Applied Surface Science 2019; 484:479-88.
[44] Cheng Q, Li Y, Wang Z, Wang X, Zhang G. Boosting full-spectrum light driven surface lattice oxygen activation of ZnMn2O4 by facet engineering for highly efficient photothermal mineralization of toluene. Applied Catalysis B: Environmental 2023; 324:122274.
[45] Cheng Q, Wang K, Yang Z, Li Y, Zhang G. Surface oxygen vacancies induced by cu-doping in hexagonal ZnMn2O4 nanoplates for high efficiency photothermocatalytic oxidation of toluene. Separation and Purification Technology 2025; 354:128743.
[46] Yu E, Chen J, Jia H. Enhanced light-driven photothermocatalytic activity on selectively dissolved LaTi1-xMnxO3+ δ perovskites by photoactivation. Journal of Hazardous Materials 2020; 399:122942.
[47] Li J-J, Yu E-Q, Cai S-C, Chen X, Chen J, Jia H-P, et al. Noble metal free, CeO2/LaMnO₃ hybrid achieving efficient photo-thermal catalytic decomposition of volatile organic compounds under IR light. Applied Catalysis B: Environmental 2019; 240:141-52.
[48] Li J, Zhang M, Elimian E A, Lv X, Chen J, Jia H. Convergent ambient sunlight-powered multifunctional catalysis for toluene abatement over in situ exsolution of Mn3O4 on perovskite parent. Chemical Engineering Journal 2021; 412:128560.
[49] Yang Y, Zhao S, Bi F, Chen J, Wang Y, Cui L, et al. Highly efficient photothermal catalysis of toluene over Co3O4/TiO2 pn heterojunction: The crucial roles of interface defects and band structure. Applied Catalysis B: Environmental 2022; 315:121550.
[50] Sun C, Alonso J A, Bian J. Recent Advances in Perovskite-Type Oxides for Energy Conversion and Storage Applications. Advanced Energy Materials 2021; 11(2):2000459.
[51] Liu L, Li Z, Wang Y, Li Z, Larring Y, Cai N. Industry-scale production of a perovskite oxide as oxygen carrier material in chemical looping. Chemical Engineering Journal 2022; 431:134006.
[52] Zhang R, Qin C, Bala H, Wang Y, Cao J. Recent Progress in Spinel Ferrite (MFe2O4) Chemiresistive Based Gas Sensors. Nanomaterials. 13. 2023.
[53] Kandasamy G. Recent advancements in manganite perovskites and spinel ferrite-based magnetic nanoparticles for biomedical theranostic applications. Nanotechnology 2019; 30(50):502001.

What is claimed is:

1. A catalyst composition comprising:
a photothermal perovskite oxide; and
at least one transition metal spinel ferrite, wherein a ratio of the photothermal perovskite oxide to at least one transition metal spinel ferrite is from 1:10 to 10:1.

2. The catalyst composition of claim 1, wherein the at least one transition metal spinel ferrite has a formula AₓB₃₋ₓO₄, wherein:
A is selected from Co, Cu, Ni, Zn, Mn, and Fe;
B is Fe; and
O is oxygen.

3. The catalyst composition of claim 2, wherein the at least one transition metal spinel ferrite comprises NiFe₂O₄, CoFe₂O₄, CuFe₂O₄, or Co_{0.5}Ni_{0.5}Fe₂O₄.

4. The catalyst composition of claim 1, wherein the photothermal perovskite oxide has a formula of ABO₃, wherein:
A is an alkaline earth metal or rare earth metal cation;
B is a transition-metal cation; and
O is oxygen.

5. The catalyst composition of claim 4, wherein the photothermal perovskite oxide is independently selected from a group consisting of lanthanum manganite, strontium titanate, calcium titanate, lead titanate, bismuth ferrite, lanthanum cobaltite, lanthanum nickelate, lanthanum ferrite, and lanthanum ytterbium oxide.

6. The catalyst composition of claim 1, wherein the catalyst is a nanofiber.

7. A method of producing a heterostructure, the method comprising:
preparing solution (a) comprising:
combining water, methanol, and glacial acetic acid to produce a first co-solvent system;
adding, to the first co-solvent system, polyvinylpyrrolidone polymer to produce a first mixture; and
adding, to the first mixture, a first metal ferrite precursor salt, to produce solution (a); and
preparing solution (b) comprising:
combining water, methanol, and acetic acid to produce a second co-solvent system;
adding, to the second co-solvent system, polyvinylpyrrolidone polymer to produce a second mixture;
adding, to the second mixture, at least two acetate salts, wherein the at least two acetate salts are different, to produce solution (b);
stirring solution (b) at room temperature;
decreasing a pH to 1.5 to fully dissolve the at least two acetate salts;
spraying solution (a) through a first needle onto a rotating drum;
spraying solution (b), simultaneously with solution (a), through a second needle onto the rotating drum, wherein the first needle and the second needle are configured concentrically, to produce a mixing zone at an exit end of the first needle and the second needle;
rotating the drum at room temperature and simultaneously collecting a precursor fiber; and
heating, in a furnace, the precursor fiber to produce a spinel ferrite/perovskite oxide catalyst.

8. The method of claim 7, wherein the rotating drum has a rotation of 1000 to 1500 RPM.

9. The method of claim 7, wherein the first needle and the second needle have a tip-to drum distance of from 10 cm to 20 cm, and wherein solution (a) and solution (b) are independently injected at a rate of from 0.2 mL/h to 1.5 mL/h.

10. The method of claim 7, wherein the rotating drum comprises at least one layer of aluminum tape positioned on an outer surface of the rotating drum.

11. The method of claim 7, wherein a mass of polyvinylpyrrolidone polymer (PVP) is added to solution (a) and/or solution (b) according to formula (i), wherein formula (i) is
$$\% wt ( PVP ) = \frac{{mass}_{( PVP )}}{{mass}_{( PVP )} + {mass}_{( solvent mixture )} + {mass}_{( metal precursor salts )}} \times 100 \%$$

12. The method of claim 7, wherein the water, methanol, and glacial acetic acid used in the first co-solvent system and in the second co-solvent system is a 5:30:3 (v/v/v) ratio.

13. The method of claim 7, wherein a weight ratio of a total metal moles-to-volume ratio of the total metal to co-solvent is from about 0.10 mol/L to 0.50 mol/L.

14. The method of claim 7, further comprises:
adding a second metal ferrite precursor salt to the first mixture, wherein a ratio of the first metal ferrite precursor to the second metal ferrite precursor is 1:2.

15. The method of claim 14, wherein the first metal ferrite precursor salt and the second metal ferrite precursor salt have a formula of AₓB₃₋ₓO₄, wherein:
A is selected from Co, Cu, Ni, Zn, Mn, and Fe;
B is Fe; and
O is oxygen.

16. The method of claim 15, wherein the first metal ferrite precursor salt and the second metal ferrite precursor salt comprises NiFe₂O₄, CoFe₂O₄, or Co_{0.5}Ni_{0.5}Fe₂O₄.

17. The method of claim 7, wherein the furnace is heated to a temperature range of from 300° C. to 800° C.

18. A method of catalyzing a reaction comprising:
adding, to a reaction, the catalyst of claim 1;
applying light to the reaction for a period of time to sufficiently increase a temperature of the reaction, wherein the light to the reaction is at a wavelength that overlaps with a bandgap of the catalyst.

19. The method of catalyzing a reaction of claim 18, wherein a reaction chamber where the reaction passes through, is maintained at a temperature of from 25° C. to 200° C.

20. The method of catalyzing a reaction of claim 18, wherein a rate of conversion is from 50% to 100% during continuous flow, and wherein the catalyst maintains a crystal structure for at least 10 hours of consecutive cycling use.
